(19) United States
(12) Patent Application Publication
(10) Pub. No.: US 2003/0138208 A1
(43) Pub. Date: Jul. 24, 2003

(54) Grating optical waveguide structure for multi-analyte determinations and the use thereof

(76) Inventors: Michael Pawlak, Laufenberg (DE); Markus Ehrat, Magden (CH); Gert Ludwig Duveneck, Bad Krozingen (DE); Martin Andreas Bopp, Basel (CH)

Correspondence Address: WENDEROTH, LIND & PONACK, L.L.P., 2033 K STREET N. W., SUITE 800, WASHINGTON, DC, 20006-1021, US

(21) Appl. No.: 10/275,380

(22) PCT Filed: Jan. 19, 2001
(86) PCT No.: PCT/EP01/00605

(30) Foreign Application Priority Data
May 6, 2000 (CH) 88800
Oct. 26, 2000 (CH) 209500

(51) Int. Cl. G02B 6/34

(52) U.S. Cl. 385/37; 385/12; 422/82.11

(57) ABSTRACT

The invention relates to variable embodiments of a grating waveguide structure which enables to determine locally resolved changes of the resonance conditions for the incoupling of an excitation light into the waveguiding layer (a) of a stratified optical waveguide by means of a grating structure (c) modulated in said layer (a) or for outcoupling of a light guided in layer (a). The inventive system comprises arrays of measurement areas produced on the grating waveguide structure having different immobilized biological or biochemical or synthetic recognition elements elements for simultaneously binding and determining one or more analytes, wherein said excitation light is simultaneously irradiated onto an entire array of measurement areas, and the degree of satisfaction of the resonance condition for the incoupling of light into the layer (a) towards said measurement areas is simultaneously measured. The invention also relates to an optical system comprising at least one excitation light source and at least one locally resolving detector and, optionally, positioning elements for altering the angle of incidence of the excitation light onto the inventive grating waveguide structure. The invention additionally relates to a corresponding measuring method and to the use thereof. Surprisingly, it has been found that the inventive method is well-suited as an imaging detection method with high local resolution and sensitivity.

The invention relates to variable embodiments of a grating waveguide structure which enables to determine locally resolved changes of the resonance conditions for the incoupling of an excitation light into the waveguiding layer (a) of a stratified optical waveguide by means of a grating structure (c) modulated in said layer (a) or for outcoupling of a light guided in layer (a). The inventive system comprises arrays of measurement areas produced on the grating waveguide structure having different immobilized biological or biochemical or synthetic recognition elements elements for simultaneously binding and determining one or more analytes, wherein said excitation light is simultaneously irradiated onto an entire array of measurement areas, and the degree of satisfaction of the resonance condition for the incoupling of light into the layer (a) towards said measurement areas is simultaneously measured. The invention also relates to an optical system comprising at least one excitation light source and at least one locally resolving detector and, optionally, positioning elements for altering the angle of incidence of the excitation light onto the inventive grating waveguide structure. The invention additionally relates to a corresponding measuring method and to the use thereof. Surprisingly, it has been found that the inventive method is well-suited as an imaging detection method with high local resolution and sensitivity.

It shall be understood as a “locally resolved” determination of a physical parameter, of its distribution over a measurement surface to be analyzed, which is preferably planar, that an unequivocal value, as a function of the x- and y-coordinates, with respect to said measurement area, can be attributed to this parameter based on a corresponding measurement. Thereby, the local resolution achievable at best is, for example, limited by the resolution of the detection system.

For the determination of a multitude of analytes currently mainly such methods find widespread application, wherein the determination of different analytes is performed in discrete sample compartments or “wells” of such plates. The most widespread are plates with an arrangement of 8×12 wells on a footprint area of about 8 cm×12 cm, whereby a volume of some hundred microliters is required for filling an individual well. However, it would be desirable for many applications to determine several analytes in a single sample compartment, upon application of a sample volume as small as possible.

In U.S. Pat. No. 5,747,274, measurement arrangements and methods for the early recognition of a cardiac infarction, upon determination of several from at least three infarction markers, are described, wherein the determination of these markers can be performed in individual sample compartments or in a common sample compartment, a single (common) sample compartment being provided, according to the disclosure for the latter case, as a continuous flow channel, one demarcation of which being formed, for example, by a membrane, whereon antibodies for the three different markers are immobilized. However, there are no hints for an arrangement of several sample compartments or flow channels of this type on a common support. Additionally, there are no geometrical informations concerning the size of the measurement areas.

In the patent application WO 84/01031 and U.S. Pat. Nos. 5,807,755, 5,837,551 and 5,432,099 the immobilization of recognition elements specific for the analyte in form of small “spots” with an area partially significantly below 1 mm² on a solid support is proposed, in order to be able to perform a determination of the concentration of an analyte that is only dependent on the incubaton time, but essentially independent from the absolute sample volume—in the absence of a continuous flow—by means of binding only a small fraction of available analyte molecules. The measurement arrangements described in the related examples of applications are based on fluorescence methods in conventional microtiter plates. Thereby, also arrangements are described, wherein spots of up to three different fluorescently labeled antibodies are measured in a common microtiter plate well. Following the theoretical evaluations outlined in these patent disclosures, a minimization of the spot size would be desirable. As a limitation, however, the minimum signal height to be distinguished from the background signal was considered.

For achieving lower detection limits, numerous measurement arrangements have been developed in the last years, wherein the determination of an analyte is based on its interaction with the evanescent field, which is associated with light guiding in an optical waveguide, wherein biochemical or biological recognition elements for the specific recognition and binding of the analyte molecules are immobilized on the surface of the waveguide.

When a light wave is coupled into an optical waveguide surrounded by optically rarer media, i.e. media of lower refractive index, the light wave is guided by total reflection at the interfaces of the waveguiding layer. In that arrangement, a fraction of the electromagnetic energy penetrates the media of lower refractive index. This portion is termed the evanescent (=decaying) field. The strength of the evanescent field depends to a very great extent on the thickness of the waveguiding layer itself and on the ratio of the refractive indices of the waveguiding layer and of the media surrounding it. In the case of thin waveguides, i.e. layer thicknesses that are the same as or smaller than the wavelength of the light to be guided, discrete modes of the guided light can be distinguished. As an advantage of such methods, the interaction with the analyte is limited to the penetration depth of the evanescent field into the adjacent medium, being of the order of some hundred nanometers, and interfering signals from the depth of the (bulk) medium can be mainly avoided. The first proposed measurement arrangements of this type were based on highly multi-modal, self-supporting single-layer waveguides, such as fibers or plates of transparent plastics or glass, with thicknesses from some hundred micrometers up to several millimeters.

In WO 94/27137, measurement arrangements are disclosed, wherein “patches” with different recognition elements, for the determination of different analytes, are immobilized on a self-supporting optical substrate waveguide (single-layer waveguide), excitation light being incoupled at the distal surfaces (“front face” or “distal end” coupling), wherein laterally selective immobilization is performed using photo-activatable cross-linkers. According to the disclosure, several patches can be arranged row-wise in common, parallel flow channels or sample compartments, wherein the parallel flow channels or sample compartments extend over the whole length of the range on the waveguide used as a sensor, in order to avoid an impairment of light guiding in the waveguide. However, there are no hints to a two-dimensional integration of multiple patches in sample compartments of relatively small dimensions, i.e. on a base area of significantly below 1 cm². In a similar arrangement disclosed in WO 97/35203, several embodiments of an arrangement are described, wherein different recognition elements for the determination of different analytes are immobilized in separate, parallel flow channels or sample compartments for the sample and for calibration solutions of low and, optionally in addition, of high analyte concentration. Again, no hint is given how a high integration density of different recognition elements in a common compartment for a supplied sample could be achieved. Furtheron, the sensitivity of highly multi-modal, self-supporting single-layer waveguides is not sufficient for a variety of applications requiring achieving very low detection limits.

For an improvement of the sensitivity and simultaneously for an easier manufacturing in mass production, planar thin-film waveguides have been proposed. In the simplest case, a planar thin-film waveguide consists of a three-layer system: support material (substrate), waveguiding layer, superstrate (respectively the sample to be analyzed), wherein the waveguiding layer has the highest refractive index. Additional intermediate layers can further improve the action of the planar waveguide.

Several methods for the incoupling of excitation light into a planar waveguide are known. The methods used earliest were based on front face coupling or prism coupling, wherein generally a liquid is introduced between the prism and the waveguide, in order to reduce reflections due to air gaps. These two methods are mainly suited with respect to waveguides of relatively large layer thickness, i.e. especially self-supporting waveguides, and with respect to waveguides with a refractive index significantly below 2. For incoupling of excitation light into very thin waveguiding layers of high refractive index, however, the use of coupling gratings is a significantly more elegant method.

Different methods of analyte determination in the evanescent field of lightwaves guided in stratified optical waveguides can be distinguished. Based on the applied measurement principle, for example, it can be distinguished between fluorescence, or more general luminescence methods, on one side and refractive methods on the other side. In this context methods for generation of surface plasmon resonance in a thin metal layer on a dielectric layer of lower refractive index can be included in the group of refractive methods, if the resonance angle of the launched excitation light for generation of the surface plasmon resonance is taken as the quantity to be measured. Surface plasmon resonance can also be used for the amplification of a luminescence or the improvement of the signal-to-background ratios in a luminescence measurement. The conditions for generation of a surface plasmon resonance and the combination with luminescence measurements, as well as with waveguiding structures, are described in the literature, for example in U.S. Pat. No. 5,478,755, U.S. Pat. No. 5,841,143, U.S. Pat. No. 5,006,716, and U.S. Pat. No. 4,649,280.

In this application, the term “luminescence” means the spontaneous emission of photons in the range from ultraviolet to infrared, after optical or other than optical excitation, such as electrical or chemical or biochemical or thermal excitation. For example, chemiluminescence, bioluminescence, electroluminescence, and especially fluorescence and phosphorescence are included under the term “luminescence”.

In case of the refractive measurement methods, the change of the effective refractive index resulting from molecular adsorption to or desorption from the waveguide is used for analyte detection. This change of the effective refractive index is determined, in case of grating coupler sensors, from changes of the coupling angle for the in- or out-coupling of light into or out of the grating coupler sensor, in case of interferometric sensors from changes of the phase difference between measurement light guided in a sensing branch and a referencing branch of the interferometer.

The state of the art for using one or more coupling gratings for the in- and/or outcoupling of guided waves (by means of one or more coupling gratings) is described, for example, in K. Tiefenthaler, W. Lukosz,“Sensitivity of grating couplers as integrated-optical chemical sensors”, J. Opt. Soc. Am. B6, 209 (1989); W. Lukosz, Ph.M. Nellen, Ch. Stamm, P. Weiss, “Output Grating Couplers on Planar Waveguides as Integrated, Optical Chemical Sensors”, Sensors and Actuators B1, 585 (1990); and in T. Tamir, S. T. Peng, “Analysis and Design of Grating Couplers”, Appl. Phys. 14, 235-254 (1977).

In U.S. Pat. No. 5,738,825 an arrangement is described comprising a microtiter plate with wells extending through it and a thin-film waveguide as a base plate, the later consisting of a thin waveguiding film on a transparent, self-supporting substrate. Diffractive gratings for the incoupling and outcoupling of excitation light are provided in contact with the open sample compartments formed by the wells of the microtiter plate and the thin-film waveguide as the base plate, in order to determine changes of the effective refractive index caused by adsorption or desorption of analyte molecules to be determined from changes of the observed coupling angle. However, a determination of multiple analytes within one sample compartment, upon binding to different recognition elements immobilized on the grating structure in the sample compartment, is not intended and would also hardly be realizable, according to the waveguide and grating parameters given in the examples. As a consequence, the density of different measurement areas with different recognition elements for the determination of different analytes to be determined independent from one another, that can be achieved with this arrangement, is also not sufficient for many applications (like the determination of a multitude of different nucleic acid sequences in small-volume sample, i.e. of <100 μl volume).

In U.S. Pat. No. 5,991,480 another type of grating coupler sensor is proposed, wherein the angle between the sensor platform, with a grating structure modulated in its waveguiding layer, and the excitation light ray is not changed, but the position of incoupling of light on the grating waveguide structure is varied essentially in parallel to the grating lines, upon a variation of the coupling conditions. For example, this affect is achieved upon using a so-called “chirped grating”, wherein the “chirped grating” is characterized by a continuous change of the grating period essentially in parallel to the grating lines. This arrangement has especially the advantage of a large potential for a miniaturization of the measurement arrangement (including light source and a locally resolving detector), especially as mechanical positioning elements are not required. Thereby however, the dimensions of discrete regions with “chirped gratings” for incoupling and outcoupling of light can hardly be reduced to dimensions below some square millimeters.

With respect to grating waveguide structures, further phenomena are known, which have found no or hardly any application for analytical measurement methods so far. In especial, an almost complete disappearance of the transmitted light and an increase of the light emitted in direction of the reflected light up to almost 100% can be observed upon adequate choice of the parameters (such as the grating period, and grating depth, thickness of the optically transparent layer (a) of an optical waveguide, as well as of its refractive index and of the refractive indices of the adjacent media). The physical conditions for the disappearance of the transmission light and the simultaneous appearance of an extraordinary “reflection” (as the sum of the regular portion of the reflection, in accordance with the radiation laws, and of the light that is outcoupled by the grating structure) are, for exampled, described and explained in D, Rosenblatt et al., “Resonant Grating Waveguide Structures”, IEEE Journal of Quantum Electronics, vol. 33 (1997) 2038-2059. In all these studies, however, only the fractions of transmitted and reflected light, which are available in the far-field of the grating structure, are described and explained by physical models. There are no hints at all on the distribution of the electromagnetic field strength or of the intensity at the surface of the structure, and especially no hints on variations of transmission or “reflection” within an area on a coupling grating irradiated at resonance conditions.

The named refractive methods are characterized by the advantage that they can be applied without using so-called molecular labels as marker molecules. However, in none of the named refractive measurement methods using grating couplers for an analyte determination based on the determination of the coupling conditions respectively of the coupling angle, resulting from molecular adsorption to or desorption from the coupling grating, a hint is given on a locally resolved detection within a light bundle irradiated onto a coupling grating. For a determination of a multitude of analytes on a small area, these methods have been therefore not appropriate or only hardly appropriate.

Therefore there is a need for a method allowing to apply the advantages of labelfree analyte detection also for the determination of a multitude of analytes in a small-volume sample on high-density arrays.

It is the objective of the present invention to provide a grating waveguide structure, an optical system and a measurement method for label-free analyte detection using arrays of high density, for the determination defined above.

In the spirit of this invention, spatially separated measurement areas (d) shall be defined by the area that is occupied by biological or biochemical or synthetic recognition elements immobilized thereon, for recognition of one or multiple analytes in a liquid sample. These areas can have any geometry, for example the form of dots, circles, rectangles, triangles, ellipses or lines. Thereby, spatially separated measurement areas (d) can be generated by spatially selective deposition of biological or biochemical or synthetic recognition elements on the grating waveguide structure. When an analyte or an anologue of the analyte competing with the analyte for the binding to the immobilized recognition elements, or a further binding partner in a multi-step assay is brought into contact with the recognition elements, these molecules will be bound selectively only in the measurement areas on the surface of the grating waveguide structure, which are defined by the areas occupied by the immobilized recognition elements.

Surprisingly, it has now been found that differences of the degree of satisfaction of the resonance condition for incoupling of light, i.e. local differences of the mass coverage of a grating structure, provided as generated measurement areas with biological recognition elements such as oligonucleotides, can be determined with high local resolution (of 50 μm or less) and with a large contrast, i.e., with a high sensitivity for determining differences or changes of the mass coverage, when using a grating waveguide structure (GWS) according to the invention, for example with a grating structure modulated in the waveguiding layer and extending over the whole surface of the GWS, especially upon large-area illumination (i.e. with a beam diameter of, for example, 5 mm) at or close to the resonance condition for the incoupling of the light into layer (a). Thereby, the local resolution and the contrast are surprisingly so good, that the method according to the invention is even well-suited as an imaging method, for the simultaneous topological characterization of the mass coverage of an extended surface (of the order of some square millimeters up to several square centimeters. For example, camera images (e.g. in transmission and in “reflection”) can be taken sequentially, after intermediate variation of the angle of incidence of the excitation light on the grating waveguide structure, in order to determine different local mass coverages, so that minima of the transmission or maxima of the “reflection” are determined at different angles dependent on the local mass coverage. The locally resolved distribution of the mass coverage can be determined from these sequential images by numerical methods. Compared to conventional methods of analyte determination based on changes of the coupling conditions, without local resolution, the novel method according to the invention provides a multitude of advantages. These advantages are, for example, a much higher speed of the method, as sequential images can be taken at intervals of fractions of a second with exposure times of milliseconds. Furtheron, any problems of the reproducibility of the positioning, when the grating waveguide structure has always to be moved to new measurement positions between sequential local measurements of discrete measurement areas, as they are related to the named conventional methods, are eliminated. As another advantage, the novel method also allows for performing simultaneous kinetic measurements on a multitude of measurement areas within a common sample compartment on the GWS, upon repeating scans of the angle of incidence at a short repetition time, for the determination of different mass coverages on the studied surface.

A first subject of the invention is a grating waveguide structure for the locally resolved determination of changes of the resonance conditions for the incoupling of an excitation light into a waveguide or for the outcoupling of a light guided in the waveguide, comprising an array of at least two or more, laterally separated measurement areas (d) on said platform, comprising a stratified optical waveguide

with a first optically transparent layer (a) on a second optically transparent layer (b) with lower refractive index than layer (a),

with one or more grating structures (c) for the incoupling of an excitation light towards the measurement areas (d) or for the outcoupling of a light guided in layer (a) in the region of the measurement areas

with at least one or more laterally separated measurement areas (d) on said one or more grating structures (c)

with equal or different biological or biochemical or synthetic recognition elements (e) immobilized on said measurement areas, for the qualitative and/or quantitative determination of one or more analytes in a sample brought into contact with said measurement areas,

wherein said excitation light is irradiated simultaneously onto said array of measurement areas, and the degree of satisfaction of the resonance condition for the incoupling of light into the layer (a) towards said two or more measurement areas is simultaneously measured and a cross-talk of excitation light guided in layer (a), from one measurement area to one or more adjacent measurement areas is prevented by outcoupling said excitation light again by means of the grating structure (c).

A grating waveguide structure according to the invention allows to determine simultaneously the mass coverage in a multitude of measurement areas on a grating structure (c), based on the degree of satisfaction of the resonance condition for the incoupling of an excitation light bundle into the optical layer (a) in the region of the measurement areas.

A special subject of the invention is a grating waveguide structure for the locally resolved determination of changes of the resonance conditions for the incoupling of an excitation light into a waveguide or for the outcoupling of a light guided in the waveguide, comprising a two-dimensional array of at least four or more, laterally separated measurement areas (d) on said platform, comprising a stratified optical waveguide

with a first optically transparent layer (a) on a second optically transparent layer (b) with lower refractive index than layer (a),

with one or more grating structures (c) for the incoupling of an excitation light towards the measurement areas (d) or for the outcoupling of a light guided in layer (a) in the region of the measurement areas

with at least one or more laterally separated measurement areas (d) on said one or more grating structures (c)

with equal or different biological or biochemical or synthetic recognition elements (e) immobilized on said measurement areas, for the qualitative and/or quantitative determination of one or more analytes in a sample brought into contact with said measurement areas,

wherein the density of the measurement areas on a common grating structure (c) is at least 10 measurement areas per square centimeter, said excitation light is irradiated simultaneously onto said array of measurement areas, and the degree of satisfaction of the resonance condition for the incoupling of light into the layer (a) towards said two or more measurement areas is simultaneously measured and a cross-talk of excitation light guided in layer (a), from one measurement area to one or more adjacent measurement areas is prevented by outcoupling said excitation light again by means of the grating structure (c).

It is preferred that a continuously modulated grating structure (c) extends essentially over the whole area of said grating waveguide structure.

Such embodiments of a grating waveguide structure according to the invention are preferred, which are characterized in that the lateral resolution for the determination of the degree of satisfaction of the resonance condition for incoupling of light into layer (a) is better than 200 μm. Especially preferred are embodiments which have a lateral resolution for the determination of the degree of satisfaction of the resonance condition for incoupling of light into layer (a) of better than 20 μm.

An important parameter for the variation of the lateral (local) resolution or for the sensitivity of the determination of changes of the mass coverage upon corresponding changes of the resonance conditions for the incoupling of light is the grating depth. With a grating waveguide structure according to the invention it is possible to improve the lateral resolution for the determination of the degree of satisfaction of the resonance condition for incoupling of light into layer (a) by choice of a larger modulation depth of grating structures (c) or decrease the lateral resolution by choice of a lower modulation depth of said grating structures. In a similar way, it is possible to decrease the halfwidth of the resonance angle for satisfaction of the resonance condtion for incoupling of light into layer (a) by a decrease of the modulation depth of grating structures (c) or increase the halfwidth by an increase of the modulation depth of said grating structures.

The lateral resolution or the sensitivity for the determination of changes of the effevtive refractive index on the surface of a grating waveguide structure according to the invention can also be effected essentially the choice between tranversally magnetically polarized modes (TM) and transversally electrically polarized modes (TE). In case of highly refractive waveguiding layers (a) (e.g. with a refractive index >2), which can support only the fundamental mode of an irradiated excitation light (TE₀ or TM₀, see also below) because of their small layer thickness (e.g. between 100 nm and 400 nm), TM-modes exhibit a lower attenuation, i.e., a larger propagation length within the structured region of a grating waveguide structure (e.g. with grating depths between 5 nm and 60 nm) than the corresponding TE-modes (i.e. TE-modes od the same order). This means that under the condition of similar grating depths the lateral (local) resolution is lower when using TM-modes. On the other side, the sharpness of the resonance curve for satisfaction of the condition for incoupling an excitation light into the waveguiding layer (a) by means of a grating structure (c), at similar grating parameters (grating period and depth) and layer parameters (refractive indices and layer thicknesses) of the grating waveguide structure is significantly more pronounced for TM-modes than for TE-modes. This means that the resolution of the signal intensity, i.e. the sensitivity, for the determination of the degree of satisfaction of the resonance conditions is higher for TM-modes. As a consequence, the choice between application of TM- or TE-modes has to be made dependent on the actual task of investigation.

In order to allow to determine with high sensitivity and a high lateral (local) resolution changes of said resonance conditions by means of a grating waveguide structure according to the invention, it is desired that the specified physical parameters such as refractive index and thickness of the waveguiding layer, as well as the grating period and grating depth, as parameters of the grating waveguide structure itself, which effect the sensitivity of a determination of a change of the resonance conditions, vary as small as possible within an area corresponding to the area of an array to be investigated, in order to establish stable resonance conditions, especially a unique coupling angle, outside of the measurement areas. Typically, an array of measurement areas to be investigated simultaneously has a size of at least 2 mm×2 mm. Therefore, it is advantageous, if, outside from the measurement areas, the resonance angle for incoupling or outcoupling of a monochromatic excitation light varies by no more than 0.1° (as deviation from an average value) within an area of at least 4 mm² (with orientation of the area boundaries in parallel or not in parallel to the lines of the grating structure (c)). Of course, it is of advantage if such a pronounced homogeneity of the coupling angle can be established also across a still larger area. Therefore it is preferred that the coupling angle varies by no more than 0.1° (as deviation from an average value) within an area of at least 10 mm×10 mm (with orientation of the area boundaries in parallel or not in parallel to the lines of the grating structure (c)). It is especially preferred, if the coupling angle varies by no more than 0.1° (as deviation from an average value) within an area of at least 50 mm×50 mm (with orientation of the area boundaries in parallel or not in parallel to the lines of the grating structure (c)).

A multitude of macroscopic variations of the external conditions effects said resonsance conditions. The refractive indices of the optically transparent layers (a) and (b) and of samples brought into contact with the grating waveguide structure change as a function of temperature. Therefore it is preferred that the temperature of a grating waveguide structure according to the invention is kept constant by adequate means or can be changed or adjusted in a controlled manner.

The degree of satisfaction of the resonance condition for incoupling of light can be determined in different ways with a grating waveguide structure according to the invention. One subject of the invention is an embodiment of a grating waveguide structure, wherein the degree of satisfaction of the resonance condition for incoupling of light into layer (a) towards the measurement areas is determined from the intensity of the outcoupled excitation light, outcoupled essentially in parallel to the reflected light (i.e. of the sum of both parts).

Characteristic for another embodiment is that the degree of satisfaction of the resonance condition for incoupling of light into layer (a) towards the measurement areas is determined from the intensity of the transmitted excitation light.

Characteristic for still another embodiment is that the degree of satisfaction of the resonance condition for incoupling of light into layer (a) towards the measurement areas is determined from the intensity of the scattered light of excitation light guided in layer (a) after incoupling by means of a grating structure (c).

It is also characteristic for a grating waveguide structure according to the invention, that the sum of the intensities of the reflected light and of the excitation light outcoupled essentially in parallel thereto shows a maximum upon local satisfaction of the resonance condition for incoupling of light into layer (a) in the region of said local measurement area. Thereby, the outcoupled excitation light and the reflected excitation light from one and the same measurement area cannot be distinguished in practice, as both originate from the same location and propagate into the same direction.

Simultaneously, the intensity of the transmitted excitation light shows a mimimum upon local satisfaction of the resonance condition for incoupling of light into layer (a) in the region of said local measurement area. Furtheron, the intensity of scattered light of excitation light guided in layer (a) after incoupling by means of a grating structure (c) shows a maximum upon local satisfaction of the resonance condition for incoupling of light into layer (a) in the region of said local measurement area.

The amount of the propagation losses of a mode guided in an optically waveguiding layer (a) is determined to a large extent by the surface roughness of a supporting layer below and by the absorption of chromophores which might be contained in this supporting layer, which is, additionally, associated with the risk of excitation of unwanted luminescence in this supporting layer, upon penetration of the evanescent field of the mode guided in layer (a) (into this supporting layer). Furtheron, thermal stress can occur due to different thermal expansion coefficients of the optically transparent layers (a) and (b). In case of a chemically sensitive optically transparent layer (b), consisting for example of a transparent thermoplastic plastics, it is desirable to prevent a penetration, for example through micro pores in the optically transparent layer (a), of solvents that might attack layer (b).

Therefore, it is advantageous, if an additional optically transparent layer (b′) with lower refractive index than and in contact with layer (a), and with a thickness of 5 nm-10 000 nm, preferably of 10 nm-1000 nm, is located between the optically transparent layers (a) and (b). The purpose of the intermediate layer is a reduction of the surface roughness below layer (a) or a reduction of the penetration of the evanescent field, of light guided in layer (a), into the one or more layers located below or an improvement of the adhesion of layer (a) to the one or more layers located below or a reduction of thermally induced stress within the optical sensor platform or a chemical isolation of the optically transparent layer (a) from layers located below, by sealing of micro pores in layer (a) against the layers located below.

The grating structure (c) of the grating waveguide structure according to the invention can be a diffractive grating with a uniform period or a multidiffractive grating. It is also possible that the grating structure (c) has have a laterally varying periodicity perpendicular or in parallel to the direction of propagation of the excitation light incoupled into the optically transparent layer (a).

It is preferred that the material of the second optically transparent layer (b) comprises quartz, glass, or transparent thermoplastic plastics of the group comprising, for example, poly carbonate, poly imide, or poly methylmethacrylate.

It is also preferred that the refractive index of the first optically transparent layer (a) is higher than 1.8. A variety of materials is suited for the optically transparent layer (a). Without restriction of generality, it is preferred the first optically transparent layer (a) comprises a material of the group comprising TiO₂, ZnO, Nb₂O₅, Ta₂O₅, HfO₂, or ZrO₂, especially preferably comprising TiO₂, Nb₂O₅, or Ta₂O₅.

Besides the refractive index of the waveguiding optically transparent layer (a), its thickness is the second important parameter for the generation of an evanescent field as strong as possible at the interfaces to adjacent layers with lower refractive index. With decreasing thickness of the waveguiding layer (a), the strength of the evanescent field increases, as long as the layer thickness is sufficient for guiding at least one mode of the excitation wavelength. Thereby, the minimum “cut-off” layer thickness for guiding a mode is dependent on the wavelength of this mode. The “cut-off” layer thickness is larger for light of longer wavelength than for light of shorter wavelength. Approaching the “cut-off” layer thickness, however, also unwanted propagation losses increase strongly, thus setting additionally a lower limit for the choice of the preferred layer thickness.

Preferred are layer thicknesses of the optically transparent layer (a) allowing for guiding only one to three modes at a given excitation wavelength. Especially preferred are layer thicknesses resulting in mono-modal waveguides for this given excitation wavelength. It is understood that the character of discrete modes of the guided light does only refer to the transversal modes.

As a consequence of these requirements, it is preferred that the product of the thickness of the first optically transparent layer (a) and its refractive index is one tenth to a whole, preferably one third to two thirds, of the excitation wavelength of an excitation light to be incoupled into the layer (a).

For given refractive indices of the waveguiding, optically transparent layer (a) and of the adjacent layers, the resonance angle for incoupling of the excitation light, according to the above mentioned resonance condition, is dependent on the diffraction order to be incoupled, on the excitation wavelength and on the grating period. Incoupling of the first diffraction order is advantageous for increasing the incoupling efficiency. Besides the number of the diffraction order, the grating depth is important for the amount of the incoupling efficiency. As a matter of principle, the coupling efficiency increases with increasing grating depth. The process of outcoupling being completely reciprocal to the incoupling, however, the outcoupling efficiency increases simultaneously, resulting in an optimum for the excitation of luminescence in a measurement area (d) located on or adjacent to the grating structure (c), the optimum being dependent on the geometry of the measurement areas and of the launched excitation light bundle. Based on these boundary conditions, it is advantageous, if the grating (c) has a period of 200 nm-1000 nm and a modulation depth of 3 nm-100 nm, preferably of 10 nm-30 nm.

Furtheron, it is preferred that the ratio of the modulation depth to the thickness of the first optically transparent layer (a) is equal or smaller than 0.2.

Besides the parameters already mentioned, also the “bar-to-groove ratio” has an effect on the efficiency of incoupling and outcoupling. For a rectangular grating, for example, the “bar-to-groove ratio” shall mean the ratio of the widths of the grating bars and grating grooves (dimension in parallel to the direction of propagation of the guided light). Preferably, the grating has a “bar-to-groove ratio” of 0.5-2.

Thereby, the grating structure (c) can be a relief grating with a rectangular, triangular or semi-circular profile or a phase or volume grating with a periodic modulation of the refractive index in the essentially planar, optically transparent layer (a).

It can also be advantageous, if optically or mechanically recognizable marks for simplifying adjustments in an optical system and/or for the connection to sample compartments as part of an analytical system are provided on the grating waveguide structure.

The grating waveguide structure according to the invention is especially suited for application in biochemical analytics, for the highly sensitive determination of one or more analytes in one or more supplied samples. The following group of preferences is especially intended for this application area. For these applications, biological or biochemical or synthetic recognition elements for the recognition and binding of analytes to be determined are immobilized on the grating waveguide structure. The immobilization can be performed over large areas, perhaps on the whole structure, or in discrete so-called measurement areas.

In the spirit of this invention, spatially separated measurement areas (d) shall be defined by the area that is occupied by biological or biochemical or synthetic recognition elements immobilized thereon, for recognition of one or multiple analytes in a liquid sample. These areas can have any geometry, for example the form of dots, circles, rectangles, triangles, ellipses or lines. Up to 1 000 000 measurement areas can be provided in a 2-dimensional arrangement on a grating waveguide structure according to the invention, wherein a single measurement area can occupy an area of 0.001 mm²-6 mm². Typically, the density of measurement areas on a common grating waveguide structure can be more than 10, preferably more than 100, especially preferably more than 1000 measurement areas per square centimeter.

It is also preferred that the exterior dimensions of its footprint are similar to the footprint of standard microtiter plates of about 8 cm×12 cm (with 96 or 384 or 1536 wells).

There are many methods for the deposition of the biological or biochemical or synthetic recognition elements on the optically transparent layer (a). For example, the deposition can be performed by physical adsorption or electrostatic interaction. In general, the orientation of the recognition elements is then of statistic nature. Additionally, there is the risk of washing away a part of the immobilized recognition elements, if the sample containing the analyte and reagents applied in the analysis process have a different composition. Therefore, it can be advantageous, if an adhesion-promoting layer (f) is deposited on the optically transparent layer (a), for immobilization of biological or biochemical or synthetic recognition elements. This adhesion-promoting layer should be transparent as well. In especial, the thickness of the adhesion-promoting layer should not exceed the penetration depth of the evanescent field out of the waveguiding layer (a) into the medium located above. Therefore, the adhesion-promoting layer (a) should have a thickness of less than 200 nm, preferably of less than 20 nm. The adhesion-promoting layer can comprise, for example, chemical compounds of the group comprising silanes, epoxides ,functionalized, charged or polar polymers, and “self-organized functionalized monolayers”.

For the deposition of the biological or biochemical or synthetic recognition elements one or more methods of the group of methods comprising ink jet spotting, mechanical spotting, micro contact printing, fluidic contacting of the measurement areas with the biological or biochemical or synthetic recognition elements upon their supply in parallel or crossed micro channels, upon application of pressure differences or electric or electromagnetic potentials, can be applied.

Components of the group comprising nucleic acids (for example DNA, RNA, oligonucleotides) and nucleic acid analogues (e.g. PNA), antibodies, aptamers, membrane-bound and isolated receptors, their ligands, antigens for antibodies, “histidin-tag components”, cavities generated by chemical synthesis, for hosting molecular imprints. etc., can be deposited as biological or biochemical or synthetic recognition elements.

With the last-named type of recognition elements are meant cavities, that are produced by a method described in the literature as “molecular imprinting”. In this procedure, the analyte or an analyte-analogue, mostly in organic solution, is encapsulated in a polymeric structure. Then it is called an “imprint”. Then the analyte or its analogue is dissolved from the polymeric structure upon addition of adequate reagents, leaving an empty cavity in the polymeric structure. This empty cavity can then be used as a binding site with high steric selectivity in a later method of analyte determination.

Also whole cells or cell fragments can be deposited as biological or biochemical or synthetic recognition elements.

In many cases the detection limit of an analytical method by signals caused by so-called nonspecific binding, i.e. by signals caused by the binding of the analyte or of other components applied for analyte determination, which are not only bound in the area of the provided immobilized biological or biochemical or synthetic recognition elements, but also in areas of a grating waveguide structure that are not occupied by these recognition elements, for example upon hydrophobic adsorption or electrostatic interactions. Therefore, it is advantageous, if compounds, that are “chemically neutral” towards the analyte, are deposited between the laterally separated measurement areas (d), in order to minimize nonspecific binding or adsorption. As “chemically neutral” compounds such components are called, which themselves do not have specific binding sites for the recognition and binding of the analyte or of an analogue of the analyte or of a further binding partner in a multistep assay and which prevent, due to their presence, the access of the analyte or of its analogue or of the further binding partners to the surface of the grating waveguide structure.

For example, compounds of the groups comprising albumines, especially bovine serum albumine or human serum albumine, fragmentated natural or synthetic DNA, such as from herring or salmon sperm, not hybridizing with polynuleotides to be analyzed, or uncharged but hydrophilic polymers, such as polyethyleneglycols or dextranes, can be applied as “chemically neutral” compounds.

Especially the choice of the named compounds applied for a reduction of nonspecific hybridization in polynucleotide hybridization assays (such as herring or salmon sperm) is thereby determined by the empirical preference of DNA that is “alien” for polynucleotides to be analyzed and has no known interactions with the polynucleotide sequences to be analyzed.

A further subject of the invention is an optical system for the locally resolved determination of changes of the resonance conditions for the incoupling of an excitation light into a waveguide or for the outcoupling of a light guided in the waveguide, comprising an array of at least two or more, laterally separated measurement areas (d) on said platform, comprising

at least one excitation light source

a grating waveguide structure according to the invention

at least one locally resolving detector for determination of the transmitted excitation light located at the opposite side of the grating waveguide structure, with respect to the irradiated excitation light, and/or for the determination of the light outcoupled again essentially in parallel to the reflected light at the same side of the grating waveguide structure, with respect to the direction of irradiation of the excitation light, and/or for the determination of the scattered light of an excitation light guided in layer (a) after incoupling by means of a grating structure (c).

Especially in case of the described embodiment for the collection of the light outcoupled again essentially in parallel to the reflected light if the surface of the optically transparent layer (b) facing away from the waveguiding layer (a), i.e. the opposite side of the grating waveguide structure, with respect to the irradiated excitation light, is provided with an anti-reflection coating. This can be helpful to reduce possible disturbing reflections and interference phenomena, for example caused by Fresnel reflections, which can occur independent from the measurement signals to be determined.

The described boundary conditions on the positioning of the at least one locally resolving detector at the same or at the opposite side of the grating waveguide structure, with respect to an irradiated excitation light and dependent on the fraction of light to be collected (transmitted excitation light or excitation light outcoupled again in parallel to the reflected fraction) can be simplified upon using a projection screen adequately positioned in the optical path. An adequate projection screen should be diffusively reflectant or/and diffusively transmittant. For the choice of the screen material, its granularity, especially of its surface, is of high importance. A too large granularity leads to a reduction of the contrasts and to the generation of blurred contours, i.e., to a reduction of the lateral (local) resolution and of the sensitivity. A propagation length too large in the bulk material of the screen (e.g. in a teflon block) has similar disadvantageous effects. In practice, a piece of white paper of fine granularity appears as a well suited, diffusively reflectant projection screen, which has to be positioned at the opposite side of the grating waveguide structure, with respect to the irradiated excitation light. In this example, the at least one locally resolving detector is positioned at the same side of the grating waveguide structure, with respect to the irradiated excitation light. When a diffusively transmittant projection screen is used, the detector can be positioned at both sides of the grating waveguide structure.

Such a projection screen can also advantageously be applied for the collection of the light outcoupled again essentially in parallel to the reflected light. Whereas without using such a projection screen, a locally resolving detector has to be positioned exactly in direction of propagation of this light fraction, which can be difficult to be realized in practice due to the spatial dimensions of such a detector, these requirements on the positioning are eliminated upon using such a projection screen.

It has surprisingly been found that, upon using a projection screen for the collection of the transmitted excitation light at the side opposite to the grating waveguide structure, with respect to the irradiated excitation light, an especially good contrast, for the determination of the degree of satisfaction of the resonance conditions for incoupling of light into the grating waveguide structure according to the invention could be achieved, for example when compared to the alternative configuration of the collection of the scattered light from light guided in layer (a). By means of this configuration (using a projection screen), for example, the disadvantageous contrast reduction of scattered light caused by outcoupling of guided excitation light, due to surface defects of the grating waveguide structure, can almost completely be avoided. When using an essentially parallel excitation light bundle, the distance of the projection screen from the grating waveguide structure can be varied over a wide range without a significant reduction of the sensitivity and/or of the lateral (local) resolution, as a further advantage of this configuration. For example, also the side of a sample compartment opposite to the waveguiding layer (a) of a grating waveguide structure forming the other, opposite side of the sample compartment, can be provided as a projection screen.

Therefore a further subject of the invention is an optical system for the locally resolved determination of changes of the resonance conditions for the incoupling of an excitation light into a waveguide or for the outcoupling of a light guided in the waveguide, comprising an array of at least two or more, laterally separated measurement areas (d) on said platform, comprising

at least one excitation light source

a grating waveguide structure according to the invention

at least one diffusively reflecting and/or diffusively transmitting projection screen located at the opposite side of the grating waveguide structure, with respect to the direction of irradiation of the excitation light, for generation of an image of the transmitted excitation light,

and at least one locally resolving detector for collection of the image of the transmitted excitation light from said projection screen.

Characteristic for one possible embodiment is, that the at least one locally resolving detector for collection of the image of the transmitted excitation light from said projection screen is located at the same side of the grating waveguide structure, with respect to the direction of irradiation of the excitation light.

As another possible variant, the at least one locally resolving detector for collection of the image of the transmitted excitation light from said projection screen is located at the side of the transmitted excitation light, i.e. at the opposite side of the grating waveguide structure with respect to the direction of irradiation of the excitation light, whereby said projection screen is at least partially transmittant.

For specific applications an embodiment of an optical system with a grating waveguide structure with one or more grating structures (c) with a periodicity locally varying essentially perpendicular to the direction of propagation of the excitation light incoupled into layer (a) is preferred, wherein no more than measurement area is provided on each grating structure (c) with a periodicity locally varying essentially perpendicular to the direction of propagation of the excitation light incoupled into layer (a), and wherein an unstructured area of the grating waveguide structure is provided in direction of propagation of the excitation light to be incoupled into and guided in layer (a), and wherein optionally a further grating structure (c) is provided in direction of the further propagation of the excitation light guided in layer (a), which is used to outcouple said guided excitation light towards a locally resolving detector. Such an embodiment can be designed in such a way that changes of the mass coverage, or more generally of the local effective refractive index, upon adsorption or desorption of molecules at the measurement areas on grating structures (c) result in a shift, essentially in parallel to the grating lines, of the local position of satisfaction of the resonance condition for the incoupling of the excitation light into layer (a) by means of said grating structure (c). Thereby, such an embodiment of the optical system according to the invention is preferred, wherein a one-dimensional arrangement of at least two grating structures (c) according to the specific embodiment described in this paragraph (with a periodicity locally varying essentially perpendicular to the direction of propagation of the excitation light incoupled into layer (a)) is irradiated simultaneously with excitation light. Furtheron, it is preferred that the excitation light is irradiated essentially in parallel and is essentially monochromatic. It is of special advantage, if the excitation light is irradiated linearly polarized, for excitation of a TE₀ or TM₀-mode guided in the layer (a). Preferably, a larger number of such grating structures is always irradiated simultaneously, for example a two-dimensional arrangement of at least 4 grating structures of this type.

For given layer and grating parameters of a grating waveguide structure, there are several possibilities of varying the residual free parameters for the satisfaction of the resonance conditions for the incoupling of light into or outcoupling of light out of a grating waveguide structure. In case of a sufficiently thin waveguiding layer (a) allowing only mono-modal waveguiding (TE₀ or TM₀) there is for a fixed given wavelength, for example, always only one well-defined angle (with respect to a plane perpendicular to the plane of the grating waveguide structure, in parallel to the grating lines) for which the resonance condition is satisfied, with an only small width of the related resonance curve, the width being strongly dependent on the grating depth. Accordingly, the variation of the incidence angle of the irradiated excitation light is one possible parameter for the determination respectively control of the resonance conditions.

Therefore, another subject of the invention is an optical system for the locally resolved determination of changes of the resonance conditions for the incoupling of an excitation light into a waveguide or for the outcoupling of a light guided in the waveguide, comprising a two-dimensional array of at least four or more, laterally separated measurement areas (d) on said platform, comprising

at least one excitation light source

a grating waveguide structure according to the invention

a positioning element for the change of the angle of incidence of the excitation light on the grating waveguide structure

at least one locally resolving detector for determination of the transmitted excitation light located opposite side of the grating waveguide structure, with respect to the irradiated excitation light, and/or for the determination of the light outcoupled again essentially in parallel to the the reflected light at the same side of the grating waveguide structure, with respect to the direction of irradiation of the excitation light, and/or for the determination of the scattered light of an excitation light guided in layer (a) after incoupling by means of a grating structure (c).

As already described above, the specified requirements on the positioning of the at least one locally resolving detector located at the same side or at the opposite side of the grating waveguide structure, with respect to the irradiated excitation light and dependent on the light fraction to be collected (transmitted excitation light or excitation light outcoupled again essentially in parallel to the reflected fraction) can be simplified upon using a projection screen adequately positioned in the optical path.

Accordingly, a further subject of the invention is an optical system for the locally resolved determination of changes of the resonance conditions for the incoupling of an excitation light into a waveguide or for the outcoupling of a light guided in the waveguide, comprising a two-dimensional array of at least four or more, laterally separated measurement areas (d) on said platform, comprising

at least one excitation light source

a grating waveguide structure according to the invention

a positioning element for the change of the angle of incidence of the excitation light on the grating waveguide structure

a diffusively reflecting and/or diffusively transmitting projection screen located at the opposite side of the grating waveguide structure, with respect to the direction of irradiation of the excitation light, for generation of an image of the transmitted excitation light,

and at least one locally resolving detector for collection of the image of the transmitted excitation light from said projection screen.

Often it is desired to avoid mechanically moving parts in system requiring an amout of service as low as possible, as mechanically moving parts often show a relatively high degree of wear and tear. In addition, the time required for a highly precise mechanical positioning is not negligible. As an alternative solution for given system parameters, with a fixed given angle of incidence of an irradiated excitation light on a grating waveguide structure, which is preferably adjusted close to an adequate angle for the satisfaction of the resonance conditions, a variation of the irradiated excitation wavelength is possible.

A preferred embodiment is an optical system for the locally resolved determination of changes of the resonance conditions for the incoupling of an excitation light into a waveguide or for the outcoupling of a light guided in the waveguide, comprising an array of at least two or more, laterally separated measurement areas (d) on said platform, comprising

at least one excitation light source tunable over a certain spectral range

a grating waveguide structure according to the invention

at least one locally resolving detector for determination of the transmitted excitation light located at the same side of the grating waveguide structure, with respect to the irradiated excitation light, and/or for the determination of the light outcoupled again essentially in parallel to the reflected light at the same side of the grating waveguide structure, with respect to the direction of irradiation of the excitation light, and/or for the determination of the scattered light of an excitation light guided in layer (a) after incoupling by means of a grating structure (c).

For a given grating waveguide structure, in dependence from its special parameters, there is a well-defined equivalence of a change of the coupling angle and of a change of an irradiated excitation light. For a grating waveguide structure, comprising 150 nm tantalum pentoxide (n=2.15 at 633 nm) on glass (n=1.52 at 633 nm, with a grating structure of 320 nm period (grating depth typically 10 nm- b 20 nm), for example, a change of the coupling angle by 0.2° can correspond to a change of the wavelength to be incoupled by 0.2°, for transversally electrically polarized light to be coupled-in. For such a structure, the change of the coupling angle resulting from the deposition of a complete protein monolayer is of similar order of magnitude.

It is preferred that said at least one tunable light source is tunable over a spectral range of at least 1 nm.

It is especially advantageous, if said at least one tunable light source is tunable over a spectral range of at least 5 nm.

Said at least one tunable light source can, for example, be a laser diode.

As another possible alternative, a light source that is polychromatic within a certain spectral range, preferably with a continuous spectrum within this range, can be used instead of a monochromatic light source that is tunable over said certain spectral range. On one side it is possible to generate again an almost monochromatic, tunable excitation light upon combination of such a polychromatic light source with a spectrally highly resolving optical component in the optical path, which together can then be applied like the variant described before. On the other side, it is also possible to irradiate the polychromatic of said spectral range simultaneously onto the grating waveguide structure.

Therefore, another subject of the invention is an embodiment of an optical system for the locally resolved determination of changes of the resonance conditions for the incoupling of an excitation light into a waveguide or for the outcoupling of a light guided in the waveguide, comprising an array of at least two or more, laterally separated measurement areas (d) on said platform, comprising

at least one excitation light source polychromatic within a certain spectral range

a grating waveguide structure according to the invention

at least one locally resolving detector for determination of the transmitted excitation light located at the same side of the grating waveguide structure, with respect to the irradiated excitation light, and/or for the determination of the light outcoupled again essentially in parallel to the the reflected light at the same side of the grating waveguide structure, with respect to the direction of irradiation of the excitation light, and/or for the determination of the scattered light of an excitation light guided in layer (a) after incoupling by means of a grating structure (c).

Again, its is preferred that said at least one polychromatic light source has an emission bandwidth of at least one I nm, It is especially advantageous if said at least one polychromatic emission light source has an emission bandwith of at least 5 nm.

As a consequence, that are several possible variants of a measurement method based on such an optical system according the invention, with a polychromatic light source, which are described further below.

Such an embodiment of an optical system according to the invention is preferred, which is characterized in that a spectrally selective optical component of high spectral resolution in said certain spectral range is located in the optical path between the grating waveguide structure and the at least one locally resolving detector. Thereby it is advantageous if said spectrally selective component is suitable for the generation of spectrally selective, locally resolved, two-dimensional illustrations of the intensity distributions of the measurement light emanating from the grating waveguide structure, at different wavelengths within said certain spectral range.

Especially preferred is such an embodiment of an optical system according to the invention with a polychromatic light source, wherein the locally resolved determination of changes of the resonance conditions for incoupling of an excitation light into layer (a) or outcoupling of light guided in the waveguide (layer (a)), from said polychromatic light source in the region of the measurement areas, is performed

by simultaneous or sequential collection of the transmitted excitation light and/or

by simultaneous or sequential collection of the light outcoupled again essentially in parallel to the reflected light at the same side of the grating waveguide structure, with respect to the side of irradiation of the excitation light and/or

by simultaneous or sequential collection of scattered light of excitation light guided in the layer (a) after incoupling by means of a grating waveguide structure (c),

by means of spectrally selective detection, within said certain spectral range, using at least one locally resolving detector, preferably under irradiation of the excitation light onto the grating waveguide structure at a constant angle of incidence.

For many embodiments of the optical system according to the invention it is preferred that the excitation light is irradiated essentially in parallel. An “essentially parallel” light bundle shall mean that its convergence or divergence is below 1°. Correspondingly “essentially orthogonal” or “essentially normal” shall mean that a deviation from a corresponding orthogonal or normal orientation is below 1°.

For most applications (except for the ones based on a polychromatic light source) it is also preferred that the irradiated excitation light is essentially monochromatic. An “essentially monochromatic” excitation light shall mean that its spectral bandwidth is below 1 nm.

Furtheron, it is preferred that the excitation light is irradiated linearly polarized, for excitation of a TE₀ or TM₀-mode guided in the layer (a).

Subject of the invention is especially such an embodiment of an optical system, wherein the locally resolved determination of changes of the resonance conditions for incoupling of an excitation light into layer (a) or outcoupling of light guided in the waveguide (layer (a)), in the region of the measurement areas, is performed

by sequential collection of the transmitted excitation light and/or

by sequential collection of the light outcoupled again essentially in parallel to the reflected light at the same side of the grating waveguide structure, with respect to the side of irradiation of the excitation light and/or

by sequential collection of scattered light of excitation light guided in the layer (a) after incoupling by means of a grating waveguide structure (c),

by means of one or more locally resolving detectors upon variation of the angle of incidence of the excitation light irradiated onto the grating waveguide structure.

Besides the possibility of changing the incidence angle by means of a positioning element, e.g. for performing rotary movements of the grating waveguide structure with respect to the irradiated excitation light, such a change of the incidence angle can also be performed upon using an optomechanical component located remote from the grating waveguide structure in the optical path, such as movable mirrors or prisms. Thereby, for performing only very small changes of the angle or of the local position, components driven by piezo actuators are specially well suited.

Characteristic for another embodiment of an optical system according to the invention, especially for avoiding mechanically moving parts, is that the locally resolved determination of changes of the resonance conditions for incoupling of an excitation light into layer (a) or outcoupling of light guided in the waveguide (layer (a)), in the region of the measurement areas, is performed

by sequential collection of the transmitted excitation light and/or

by sequential collection of the light outcoupled again essentially in parallel to the reflected light at the same side of the grating waveguide structure, with respect to the side of irradiation of the excitation light and/or

by sequential collection of scattered light of excitation light guided in the layer (a) after incoupling by means of a grating waveguide structure (c),

by means of one or more locally resolving detectors upon variation of the emission wavelength of a tunable light source, preferably upon irradiating the excitation light onto the grating waveguide structure at contant angle of incidence.

For the embodiments of optical systems according to the invention described above, it is preferred that the excitation light from at least one light source is expanded as homogeneously as possible to an essentially light ray bundle by means of an expansion optics and irradiated onto the one or more measurement areas. It is advantageous, if the irradiated excitation light bundle has, at least in one dimension, a diameter of at least 2 mm, preferably of at least 10 mm.

Characteristic for another preferred embodiment is, that the excitation light from the at least one light source is multiplexed to a plurality of individual rays of intensity as uniform as possible by a diffractive optical element, or in case of multiple light sources by multiple diffractive optical elements, which are preferably Dammann gratings, or by refractive optical elements, which are preferably microlens arrays, the individual rays being launched essentially parallel to each other onto laterally separated measurement areas.

Characteristic for another embodiment of an optical system according to the invention is that the excitation light from at least one, preferably monochromatic light source is expanded to a ray bundle of intensity as homogeneous as possible, with a slit-type cross-section (in a plane perpendicular to the optical axis of the optical ray path), the main axis being oriented in parallel to the grating lines, by means of a beam shaping optics, wherein the individual rays of the ray bundle are essentially in parallel to each other in a plane of projection in parallel to the plane of the grating waveguide structure, and wherein said ray bundle has a convergence or divergence with a certain convergence or divergence angle in a plane perpendicular to the plane of the grating waveguide structure.

Thereby it is preferred that said convergence angle or divergence angle of said ray bundle has a value below 5° in a plane perpendicular (orthogonal, normal) to the plane of the grating waveguide structure.

Especially preferred is if that said convergence angle or divergence angle of said ray bundle has a value below 1° in a plane perpendicular (orthogonal, normal) to the plane of the grating waveguide structure.

Characteristic for such an optical system according to the invention is, that the locally resolved determination of changes of the resonance conditions for incoupling of an excitation light into layer (a) or outcoupling of light guided in the waveguide (layer (a)), in the region of the measurement areas, within an irradiated region of slit-type cross-section, is performed

by simultaneous collection of the transmitted excitation light and/or

by simultaneous collection of the light outcoupled again essentially in parallel to the reflected light at the same side of the grating waveguide structure, with respect to the side of irradiation of the excitation light and/or

by simultaneous collection of scattered light of excitation light guided in the layer (a) after incoupling by means of a grating waveguide structure (c),

by means of one or more locally resolving detectors, wherein the local change of the resonance conditions in a measurement area is monitored

by a shift of the intensity maximum of the light emanating essentially in parallel to the reflected light from said measurement area and

by a shift of the intensity maximum of the scattered light of excitation light guided in the layer (a) after incoupling by means of a grating waveguide structure (c) and

by a shift of the intensity minimum of the light transmitted in the region of said measurement area

(in each case at the condition of satisfaction of the resonance conditions in said measurement area),

wherein the shift of said intensity maximum respectively intensity minimum occurs in a plane in parallel to the plane of the grating waveguide structure, perpendicular to the grating lines.

It is also characteristic for such an optical system that the extent of the changes of said resonance conditions and thus of the changes of the effective refractive index in the region of said measurement area can be determined from the extent of said shifts of said intensity maximum respectively intensity minimum.

For certain applications it is preferred that two or more coherent light sources with equal or different emission wavelength are used as excitation light sources.

For such applications wherein two or more different excitation wavelengths shall be applied, it is preferred such an embodiment of the optical system, wherein the excitation light of two or more coherent light sources is irradiated simultaneously or sequentially from different directions onto a grating structure (c), which is provided as superposition of grating structures with different periodicity.

It is preferred that a laterally resolving detector of the group comprising, for example, CCD cameras, CCD chips, photodiode arrays, avalanche diode arrays, multichannel plates and multichannel photomultipliers, is used for signal detection.

According to the invention, the optical system comprises such embodiments characterized in that optical components of the group comprising lenses or lens systems for the shaping of the transmitted light bundles, planar or curved mirrors for the deviation and optionally additional shaping of the light bundles, prisms for the deviation and optionally spectral separation of the light bundles, dichroic mirrors for the spectrally selective deviation of parts of the light bundles, neutral density filters for the regulation of the transmitted light intensity, optical filters or monochromators for the spectrally selective transmission of parts of the light bundles, or polarization selective elements for the selection of discrete polarization directions of the excitation or luminescence light are located between the one or more excitation light sources and the grating waveguide structure according to the invention and/or between said grating waveguide structure and the one or more detectors.

It is possible that the excitation light is launched in pulses with a duration of 1 fsec to 10 min and the emission light from the measurement areas is measured time-resolved. Such an embodiment also especially allows for observing locally resolved the binding of one or more analytes to the recognition elements in the different measurement areas in real-time. From the signals collected time-resolved, the corresponding binding kinetics can be determined. This opportunity, for example, allows for the comparison of the affinities of different ligands to a corresponding immobilized biological or biochemical or synthetic recognition element. Thereby any binding partner of such an immobilized recognition element shall be called a “ligand” in this context.

It is possible that launching of the excitation light and detection of the light emanating from the one or more measurement areas is performed sequentially for one or more measurement areas. This can be realized in practice especially when sequential excitation and detection is performed using movable optical components of the group comprising mirrors, deviating prisms, and dichroic mirrors.

Part of the invention is also such an optical system wherein sequential excitation and detection is performed using an essentially angle and focus preserving scanner. It is also possible that the grating waveguide structure is moved between steps of sequential excitation and detection.

A further part of the invention is an optical system for the locally resolved determination of changes of the resonance conditions for the incoupling of excitation light into a waveguide or outcoupling of a light guided in said waveguide, with an array of at least two or more measurement areas (d) on said platform, for the determination of one or more analytes in at least one sample on one or more measurement areas on a grating waveguide structure, with

a grating waveguide structure according to the invention

an optical system according to the invention and to any of the embodiments described above and additionally

supply means for bringing the one or more samples into contact with the measurement areas on the grating waveguide structure.

The optical system accomplished by the supply means shall also be called an analytical system in the following.

It is preferred that the analytical system additionally comprises one or more sample compartments, which are at least in the area of the one or more measurement areas or of the measurement areas combined to segments open towards the grating waveguide structure, wherein the sample compartments preferably each have a volume of 0.1 nl-100 μl.

It is preferred that the temperature of an analytical system according to the invention can be kept constant by adequate means or modified and adjusted in a controlled manner. This preferred possibility for temperature control and regulation also comprises said sample compartments, the supply means of which and optionally provided storage compartments for samples and/or reagents and optionally their storage locations for an application in an analytical respectively optical system according to the invention, besides a grating waveguide structure according to the invention and any of the described embodiments.

A possible embodiment of the analytical system according to the invention consists in that the sample compartments are closed, except for inlet and/or outlet openings for the supply or outlet of samples, at their side opposite to the optically transparent layer (a), and wherein the supply or the outlet of the samples and optionally of additional reagents is performed in a closed flow through system, wherein, in case of liquid supply to several measurement areas or segments with common inlet and outlet openings, these openings are preferably addressed row by row or column by column.

Characteristic for another possible embodiment is that the sample compartments have openings for the locally addressed supply or removal of the samples or the other reagents at the side facing away from the optically transparent layer (a).

A further development of the analytical system according to the invention is designed in such a way, that wherein compartments for reagents are provided, which reagents are wetted during the assay for the determination of the one or more analytes and contacted with the measurement areas.

A further subject of the invention is a method for the qualitative and/or quantitative determination of one or more analytes in one or more samples on at least two or more laterally separated measurement areas on a grating waveguide structure according to any of the embodiments described above, upon determination of changes of the resonance conditions for incoupling of an excitation light into a waveguide comprising an array of at least two or more laterally separated measurement areas (d) on said platform, wherein the excitation light from at least one excitation light source is irradiated onto a grating waveguide structure (c) with said measurement areas located thereon, and wherein the degree of satisfaction of the resonance condition for the incoupling of light into the layer (a) towards said measurement areas is determined from the signal of at least one locally resolving detector for the collection of the transmitted excitation light at the opposite side of the grating waveguide structure, with respect to the irradiated excitation light and/or for the collection of the light outcoupled again essentially in parallel to the reflected light at the same side of the grating waveguide structure, with respect to the direction of irradiation of the excitation light, and/or for the collection of the scattered light of an excitation light guided in layer (a) after incoupling by means of a grating structure (c).

Also subject of the invention is a method for the qualitative and/or quantitative determination of one or more analytes in one or more samples on at least two or more laterally separated measurement areas on a grating waveguide structure according to any of the embodiments described above in an optical system according to the invention, upon determination of changes of the resonance conditions for incoupling of an excitation light into a waveguide or for outcoupling of a light guided in said waveguide, comprising an array of at least two or more laterally separated measurement areas (d) on said grating waveguide structure, wherein the excitation light from at least one excitation light source is irradiated onto a grating waveguide structure (c) with said measurement areas located thereon, and wherein the degree of satisfaction of the resonance condition for the incoupling of light into the layer (a) towards said measurement areas is determined from the signal of at least one locally resolving detector for the collection of the transmitted excitation light and/or for the collection of the light outcoupled again essentially in parallel to the reflected light at the same side of the grating waveguide structure, with respect to the direction of irradiation of the excitation light, and/or for the collection of the scattered light of an excitation light guided in layer (a) after incoupling by means of a grating structure (c).

A further subject of the invention is a method for the qualitative and/or quantitative determination of one or more analytes in one or more samples on at least two or more laterally separated measurement areas on a grating waveguide structure with a periodicity laterally varying essentially perpendicular to the direction of propagation of the excitation light coupled into the optically transparent layer (a), wherein no more than one measurement area is provided on each grating structure (c) with a periodicity locally varying essentially perpendicular to the direction of propagation of the excitation light incoupled into layer (a), and wherein an unstructured region of the grating waveguide structure is provided in direction of further propagation of the excitation light to be incoupled into and guided in layer (a), and wherein optionally a further grating structure (c) is provided in direction of the still further propagation of the excitation light guided in layer (a), which last grating structure is used to outcouple again said guided excitation light towards a locally resolving detector.

Characteristic for such a method is, that changes of the local effective refractive index, especially of the mass coverage upon adsorption or desorption of molecules at the measurement areas on grating structures (c), result in a shift, essentially in parallel to the grating lines, of the local position of satisfaction of the resonance condition for the incoupling of the excitation light into layer (a) by means of said grating structure (c). It is preferred that a one-dimensional arrangement of at least two grating structures (c) of this type is irradiated simultaneously with excitation light. Preferably the excitation light is irradiated essentially in parallel and is essentially monochromatic. Thereby it is advantageous if the excitation light is irradiated linearly polarized, for excitation of a TE₀ or TM₀-mode guided in the layer (a). It is especially preferred that a two-dimensional arrangement of at least four grating structures (c) of this type is irradiated simultaneously with excitation light.

A special subject of the invention is also a method for the qualitative and/or quantitative determination of one or more analytes in one or more samples on at least two or more laterally separated measurement areas on a grating waveguide structure according to the invention, upon determination of changes of the resonance conditions for incoupling of an excitation light into a waveguide comprising a two-dimensional array of at least four or more laterally separated measurement areas (d) on said platform, wherein the excitation light from at least one excitation light source is irradiated onto a grating waveguide structure (c) with said measurement areas located thereon, and wherein the degree of satisfaction of the resonance condition for the incoupling of light into the layer (a) towards said measurement areas is determined from the signal of at least one locally resolving detector for the collection of the transmitted excitation light at the opposite side of the grating waveguide structure, with respect to the irradiated excitation light and/or for the collection of the light outcoupled again essentially in parallel to the reflected light at the same side of the grating waveguide structure, with respect to the direction of irradiation of the excitation light, and/or for the collection of the scattered light of an excitation light guided in layer (a) after incoupling by means of a grating structure (c), and wherein the angle of incidence of the excitation light on the grating waveguide structure is changed by means of a positioning element, resulting, dependent on the local refractive index, in satisfaction of said resonance condition at different angles in the regions of different measurement areas irradiated on a grating waveguide structure (c).

Preferred is a method for the qualitative and/or quantitative determination of one or more analytes in one or more samples on at least two or more laterally separated measurement areas on a grating waveguide structure according to any of the embodiments described above, upon determination of changes of the resonance conditions for incoupling of an excitation light into a waveguide or for outcoupling of a light guided in said waveguide, comprising an array of at least two or more, laterally separated measurement areas (d) on said platform, wherein the excitation light from at least one excitation light source is irradiated onto a grating waveguide structure (c) with said measurement areas located thereon, and wherein the degree of satisfaction of the resonance condition for the incoupling of light into the layer (a) towards said measurement areas is determined from the signal of at least one locally resolving detector for the collection of the transmitted excitation light, optionally upon using a diffusively reflecting and/or diffusively transmitting projection screen located at the opposite side of the grating waveguide structure, with respect to the direction of irradiation of the excitation light, for generation of an image of the transmitted excitation light, and/or from the signal of at least one locally resolving detector for the collection of the light outcoupled again essentially in parallel to the reflected light at the same side of the grating waveguide structure, with respect to the direction of irradiation of the excitation light, and/or from the signal of at least one locally resolving detector for the collection of the scattered light of an excitation light guided in layer (a) after incoupling by means of a grating structure (c), and wherein the angle of incidence of the excitation light on the grating waveguide structure is changed by means of a positioning element, resulting, dependent on the local refractive index, in satisfaction of said resonance condition at different angles in the regions of different measurement areas irradiated on a grating waveguide structure (c).

It is again preferred that the excitation light is irradiated essentially in parallel and is essentially monochromatic. Thereby it is of special advantage, if the excitation light is irradiated linearly polarized, for excitation of a TE₀ or TM₀-mode guided in the layer (a).

Characteristic for another preferred embodiment of the method according to the invention is that the locally resolved determination of changes of the resonance conditions for incoupling of an excitation light into layer (a), in the region of the measurement areas, is performed

by sequential collection of the transmitted excitation light at the opposite side of the grating waveguide structure, with respect to the irradiated excitation light and/or

by sequential collection of the light outcoupled again essentially in parallel to the reflected light at the same side of the grating waveguide structure, with respect to the side of irradiation of the excitation light and/or

by sequential collection of scattered light of excitation light guided in the layer (a) after incoupling by means of a grating waveguide structure (c),

by means of one or more locally resolving detectors upon variation of the angle of incidence of the excitation light irradiated onto the grating waveguide structure.

Characteristic for a preferred embodiment of the method according to the invention is that the locally resolved determination of changes of the resonance conditions for incoupling of an excitation light into layer (a) or outcoupling of light guided in the waveguide (layer (a)), in the region of the measurement areas, is performed

by sequential collection of the transmitted excitation light and/or

by sequential collection of the light outcoupled again essentially in parallel to the reflected light at the same side of the grating waveguide structure, with respect to the side of irradiation of the excitation light and/or

by sequential collection of scattered light of excitation light guided in the layer (a) after incoupling by means of a grating waveguide structure (c),

by means of one or more locally resolving detectors upon variation of the angle of incidence of the excitation light irradiated onto the grating waveguide structure.

Thereby it is preferred that an image of the transmitted excitation light is generated on a diffusively reflectant and/or diffusively transmittant projection screen located at the opposite side of the grating waveguide structure, with respect to the irradiated excitation light and that this image is recorded by at least one locally resolving detector.

Characteristic for a specially preferred embodiment of this method is, that the angle of incidence of the excitation light on the grating waveguide structure is adjusted in such a way that the resonance condition for incoupling of an excitation light into a waveguide with a grating waveguide structure or for outcoupling of light guided in the waveguide (layer (a)), comprising an array of at least two or more laterally separated measurement area (d) on said grating waveguide structure, is essentially satisfied

on one or more of said measurement areas, resulting in an essentially maximum signal from a locally resolving detector for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), from the region of said measurement areas and/or resulting in an essentially minimum signal from a locally resolving detector for collection of the transmitted excitation light from the region of the measurement areas

or is essentially satisfied between the measurement areas resulting in an essentially maximum signal from a locally resolving detector for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), from the regions between of measurement areas and/or resulting in an essentially minimum signal from a locally resolving setector for collection of the transmitted excitation light from the regions between the measurement areas.

If, thereby, the differences for the satisfaction of the resonance conditions on the region of the grating waveguide structure irradiated with excitation light are less than the half width of the resonance curve for the coupling angle, then an unequivocal relation between the intensity of the measured light and the degree of satisfaction of the resonance conditions (for the recorded light intensity from said region) can be derived. As a consequence, a sequential recording of resonance curves, for example upon varying the angle of incidence on the grating waveguide structure or upon varying the irradiated wavelength, is not necessary, and the information about the local degree of satisfaction of the resonance conditions and thus about the local effective refractive index can be obtained by recording a single image.

Therefore, it is preferred that local differences of the effective refractive index in the region of different measurement areas and in the regions between the measurement areas are determined from local differences of the intensities of one or more locally resolving detectors, for the transmitted excitation light and/or for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), without changing the adjusted angle of incidence of the excitation light on the grating waveguide structure.

Characteristic for another preferred embodiment of the method according to the invention is that the locally resolved determination of changes of the resonance condition for the incoupling of an excitation light, from a light source tunable at least over a certain spectral range, into layer (a) or for the outcoupling of a light guided in the waveguide (layer (a)), in the region of the measurement areas, is performed by sequential collection of the transmitted excitation light and/or by sequential collection of the light outcoupled again essentially in parallel to the reflected light at the same side of the grating waveguide structure, with respect to the side of irradiation of the excitation light and/or by sequential collection of scattered light of excitation light guided in the layer (a) after incoupling by means of a grating waveguide structure (c), using one or more locally resolving detectors in each configuration and varying the emission wavelength of said at least one tunable light source, preferably at a constant angle of incidence of the excitation light on the grating waveguide structure.

The variation of the emission wavelength of a tunable light source instead of a variation of the coupling angle, for the determination of local differences of the resonance condition, has the pronounced advantage of avoiding mechanically movable components. This method can also offer the significant advantage of the potential for a higher resolution at lower system costs: Concerning, for example, typical commercial laser diodes, the emitted laser wavelength can be controlled very precisely by means of the supplied current for operation. Thus, the generation of a very precisely adjustable excitation wavelength can be much more cost-efficient than a highly resolved angular adjustment and measurement of the angle by means of opto-mechanical components.

It is preferred that said at least one tunable light source can be tuned over a spectral range of at least 1 nm.

It is specially advantageous if said at least one tunable light source can be tuned over a spectral range of at least 5 nm.

Said at least one tunable light source can, for example, be a laser diode.

Characteristic for another preferred embodiment of the method is, that the image of the transmitted excitation light is generated on a diffusively reflectant and/or diffusively transmittant projection screen at the same side of the grating waveguide structure, with respect to the grating waveguide structure and that this image is collected with at least one locally resolving detector.

Characteristic for another preferred embodiment of the method is that the emission wavelength of at least one tunable light source is adjusted, preferably at a constant angle of incidence of this excitation light on the grating waveguide structure, in such a way that the resonance condition for incoupling of an excitation light into a waveguide of a grating waveguide structure or for outcoupling of light guided in the waveguide (layer (a)), comprising an array of at least two or more laterally separated measurement area (d) on said grating waveguide structure, is essentially satisfied

on one or more of said measurement areas, resulting in an essentially maximum signal from a locally resolving detector for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), from the region of said measurement areas and/or resulting in an essentially minimum signal from a locally resolving detector for collection of the transmitted excitation light from the region of the measurement areas

or is essentially satisfied between the measurement areas resulting in an essentially maximum signal from a locally resolving detector for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), from the regions between of measurement areas and/or resulting in an essentially minimum signal from a locally resolving detector for collection of the transmitted excitation light from the regions between the measurement areas.

If thereby the differences for the satisfaction of the resonance condition, on the region of the grating waveguide structure irradiated with excitation light, are smaller than the half width of the resonance curve for the coupling wavelength (instead of the coupling angle for the case of a fixed angle of incidence but variable excitation wavelength), then again an unequivocal relation between the intensity of the measured light and the degree of satisfaction of the resonance conditions (for the recorded light intensity from said region) can be derived. As a consequence, a sequential recording of resonance curves, for example upon varying the irradiated wavelength, is not necessary, and the information about the local degree of satisfaction of the resonance conditions and thus about the local effective refractive index can be obtained by recording a single image.

Therefore, it is preferred that local differences of the effective refractive index in the region of different measurement areas and in the regions between the measurement areas are determined from local differences of the intensities of one or more locally resolving detectors, for of the transmitted excitation light and/or for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), without changing the emission wavelength of the tunable light source.

For the embodiments of the method according to the invention described above, it is preferred that the excitation light is irradiated essentially in parallel and is essentially monochromatic. It is also preferred that the excitation light is irradiated linearly polarized, for excitation of a TE₀ or TM₀-mode guided in the layer (a).

Characteristic for another embodiment of the method according to the invention is, that the locally resolved determination of changes of the resonance condition for the incoupling of an excitation light into layer (a) or for the outcoupling of a light guided in the waveguide (layer (a)), from a polychromatic light source tunable at least over a certain spectral range, in the region of the measurement areas is performed by collection of the transmitted excitation light and/or by collection of the light outcoupled again essentially in parallel to the reflected light at the same side of the grating waveguide structure, with respect to the side of irradiation of the excitation light and/or by collection of scattered light of excitation light guided in the layer (a) after incoupling by means of a grating waveguide structure (c), using one or more locally resolving detectors in each configuration, the excitation light being preferably irradiated at a constant angle of incidence onto the grating waveguide structure, and wherein, upon satisfaction of the resonance condition of incoupling excitation light for a certain wavelength of said excitation light or outcoupling of excitation light of this wavelength guided in the waveguide a maximum signal fraction of this wavelength, as part of the signal from a locally resolving detector for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), from the region of said measurement areas and/or a minimum signal fraction of this wavelength, as part of the signal from a locally resolving detector for collection of the transmitted excitation light from the region of the measurement areas is measured.

It is again preferred that said at least one polychromatic light source has an emission bandwith of at least 1 nm. Especially advantageous is, if said at least one polychromatic light source has an emission bandwith of at least 5 nm.

Such an embodiment of the method according to the invention, using a polychromatic light source, is preferred wherein a spectrally selective optical component of high spectral resolution in said certain spectral range is located in the optical path between the grating waveguide structure and the at least one locally resolving detector. Thereby, its of advantage if said spectrally selective component is suitable for the generation of spectrally selective, locally resolved, two-dimensional illustrations of the intensity distributions of the measurement light emanating from the grating waveguide structure, at different wavelengths within said certain spectral range.

With this configuration en embodiment of the method according to the invention is made possible, wherein the locally resolved determination of changes of the resonance conditions for incoupling of an excitation light into layer (a) or outcoupling of light guided in the waveguide (layer (a)), from said polychromatic light source in the region of the measurement areas, is performed

by simultaneous or sequential collection of the transmitted excitation light and/or

by simultaneous or sequential collection of the light outcoupled again essentially in parallel to the reflected light at the same side of the grating waveguide structure, with respect to the side of irradiation of the excitation light and/or

by simultaneous or sequential collection of scattered light of excitation light guided in the layer (a) after incoupling by means of a grating waveguide structure (c),

by means of spectrally selective detection, within said certain spectral range, using at least one locally resolving detector, preferably under irradiation of the excitation light onto the grating waveguide structure at a constant angle of incidence.

For the embodiments of the method according to the invention, using a polychromatic light source and described above, it is preferred that the excitation light is irradiated essentially in parallel.

For a variety of embodiments of the method according to the invention it is specially preferred, that the excitation light from at least one light source is expanded as homogeneously as possible to an essentially light ray bundle by means of an expansion optics and irradiated onto the one or more measurement areas. Thereby, it is preferred that the irradiated excitation light bundle has, at least in one dimension, a diameter of at least 2 mm, preferably of at least 10 mm.

Characteristic for another embodiment of the method according to the invention is, that the excitation light from the at least one light source is multiplexed to a plurality of individual rays of intensity as uniform as possible by a diffractive optical element, or in case of multiple light sources by multiple diffractive optical elements, which are preferably Dammann gratings, or by refractive optical elements, which are preferably microlens arrays, the individual rays being launched essentially parallel to each other onto laterally separated measurement areas.

Characteristic for another embodiment of the method according to the invention, for the qualitative and/or quantitative determination of one or more analytes in one or more samples on at least two or more laterally separated measurement areas on a grating waveguide structure, according to the invention and any of the embodiments described above, in an optical system according to the invention, upon determination of changes of the resonance conditions for incoupling of an excitation light into a waveguide or outcoupling of a light guided in said waveguide, comprising an array of at least two or more laterally separated measurement areas (d) on said platform, wherein the excitation light from at least one, preferably monochromatic light source is expanded to a ray bundle of intensity as homogeneous as possible, with a slit-type cross-section (in a plane perpendicular to the optical axis of the optical ray path), the main axis being oriented in parallel to the grating lines, by means of a beam shaping optics, wherein the individual rays of the ray bundle are essentially in parallel to each other in a plane of projection in parallel to the plane of the grating waveguide structure, and wherein said ray bundle has a convergence or divergence with a certain convergence or divergence angle in a plane perpendicular to the plane of the grating waveguide structure.

Thereby it is preferred that the angle of convergence of divergence of said ray bundle is smaller than 5° in a plane perpendicular to the plane of the grating waveguide structure.

It is specially preferred if said angle of convergence of divergence of said ray bundle is smaller than 1° in a plane perpendicular to the plane of the grating waveguide structure.

It is characteristic for such a method according to the invention, that the locally resolved determination of changes of the resonance conditions for incoupling of an excitation light into layer (a) or outcoupling of light guided in the waveguide (layer (a)), in the region of the measurement areas, within an irradiated region of slit-type cross-section, is performed

by simultaneous collection of the transmitted excitation light and/or

by simultaneous collection of the light outcoupled again essentially in parallel to the reflected light at the same side of the grating waveguide structure, with respect to the side of irradiation of the excitation light and/or

by simultaneous collection of scattered light of excitation light guided in the layer (a) after incoupling by means of a grating waveguide structure (c),

by means of one or more locally resolving detectors, wherein the local change of the resonance conditions in a measurement area is monitored

by a shift of the intensity maximum of the light emanating essentially in parallel to the reflected light from said measurement area and

by a shift of the intensity maximum of the scattered light of excitation light guided in the layer (a) after incoupling by means of a grating waveguide structure (c) and

by a shift of the intensity minimum of the light transmitted in the region of said measurement area

(in each case at the condition of satisfaction of the resonance conditions in said measurement area),

wherein the shift of said intensity maximum respectively intensity minimum occurs in a plane in parallel to the plane of the grating waveguide structure, perpendicular to the grating lines.

It is also characteristic for this method that the extent of the changes of said resonance conditions and thus of the changes of the refractive index can be determined from the extent of said shift of the intensity minimum respectively maximum in the region of said measurement area.

This method according to the invention also comprises an embodiment wherein the locally resolved determination of changes of said resonance conditions) is performed always simultaneously in the region of the measurement areas within an irradiated region of slit-type cross-section

by simultaneous collection of the transmitted excitation light and/or

by simultaneous collection of the light outcoupled again essentially in parallel to the reflected light at the same side of the grating waveguide structure, with respect to the side of irradiation of the excitation light and/or

by simultaneous collection of scattered light of excitation light guided in the layer (a) after incoupling by means of a grating waveguide structure (c),

by means of one or more locally resolving detectors, wherein the local change of the resonance conditions in a measurement area is monitored

by a shift of the intensity maximum of the light emanating essentially in parallel to the reflected light from said measurement area and

by a shift of the intensity maximum of the scattered light of excitation light guided in the layer (a) after incoupling by means of a grating waveguide structure (c) and

by a shift of the intensity minimum of the light transmitted in the region of said measurement area

(in each case at the condition of satisfaction of the resonance conditions in said measurement area),

wherein the shift of said intensity maximum respectively intensity minimum occurs in a plane in parallel to the plane of the grating waveguide structure, perpendicular to the grating lines,

and wherein the grating waveguide structure is moved perpendicular and/or in parallel to the direction of the grating lines between sequential measurement process steps, for a sequential locally resolved determination of said resonance conditions on the whole surface of the grating waveguide structure with the measurement areas provided thereon, until the measurement signals from all measurement areas are collected and stored and a two-dimensional representation of the degree of satisfaction of said resonance condition on the whole grating waveguide structure can be generated from the stored signals.

It is characteristic for the method according to the invention and the embodiments described above, that the lateral resolution for the determination of the degree of satisfaction of the resonance condition for incoupling of light into layer (a) can be improved by choice of a larger modulation depth of grating structures (c) or decreased by choice of a lower modulation depth of said grating structures.

It is also characteristic for the method according to the invention, that the halfwidth of the resonance angle for satisfaction of the resonance condition for incoupling of light into layer (a) can be decreased by a decrease of the modulation depth of grating structures (c), resulting in an increased sensitivity for the laterally resolved determination of the degree of satisfaction of the resonance condition as a consequence from local changes of the mass coverage, or more generally from local changes of the effective refractive index, or can be increased by an increase of the modulation depth of said grating structures, resulting in .a decreased sensitivity for the laterally resolved determination of the degree of satisfaction of the resonance condition as a consequence from local changes of the mass coverage, or more generally from local changes of the effective refractive index.

It can be of special advantage for an improvement of the sensitivity, i.e. for a reduction of the halfwidth of the resonance curve for the coupling angle, if the excitation light is irradiated linearly polarized for excitation of a TM₀-mode guided in the layer (a), as typically the resonance angle for excitation of a TM₀-mode is defined more sharply by a factor of 5-10, i.e., the corresponding halfwidth smaller by this factor than the halfwidth for excitation of a TE₀-mode, at similar grating depth and thickness of the waveguiding layer (a).

Characteristic for a preferred embodiment of the method according to the invention is, that the degree of satisfaction of the resonance condition for incoupling of light into the layer (a) towards the measurement areas is determined from the intensity of the light outcoupled again essentially in parallel to the reflected light (i.e. from the sum of both fractions).

Characteristic for another preferred embodiment of the method is, that the degree of satisfaction of the resonance condition for incoupling of light into the layer (a) towards the measurement areas is determined from the intensity of the transmitted excitation light.

Characteristic for the first one of the last two described embodiments is, that the local satisfaction of the resonance condition for incoupling of light into the layer (a) towards a measurement area is determined from a maximum of the sum of the intensities of the reflected light and of the light outcoupled again essentially in parallel thereto, the two fractions of light emanating from said measurement area.

Characteristic of the second one of the last two described embodiments is, that the local satisfaction of the resonance condition for incoupling of light into the layer (a) towards a measurement area is determined from a minimum of the intensity of the transmitted excitation light at this measurement area. In ideal cases, the intensity of the transmitted excitation light can almost decrease to zero.

Several embodiments of the method according to the invention are characterized in that differences of the effective refractive index, especially of the mass coverage, can be resolved also within a measurement area. With an imaging method based on a grating coupler can therefore surprisingly a local (lateral) resolution be achieved which can compete with the local resolution of the best current scanners based on fluorescence detection for analyte determinations.

For another embodiment of the method according to the invention it is preferred that wherein two or more coherent light sources with equal or different emission wavelengths are used as excitation light sources.

As mentioned above, it is a significant advantage of the method according to the invention that the application of any labels (marker molecules to be bound to the analyte or to its binding partners) is principally not necessary. For an improvement of the sensitivity, however, a modification of the method can be advantageous, wherein a mass label, which can be selected from the group comprising metal colloids (such as gold colloids), plastic particles or beads or other microparticles with a monodisperse size distribution, is bound to the analyte molecules or to one of its binding partners in a multi-step assay, in order to increase the change of the mass coverage upon the binding to or dissociation of analyte molecules to be determined.

The method according to the invention comprises also an embodiment, wherein an “absorption label” is bound to the analyte molecules or to one of its binding partners in a multi-step assay, in order to increase the change of the effective refractive index upon binding or dissociation of analyte molecules to be determined, the “absorption label” having an absorption band of suitable wavelength resulting in a change of the effective refractive index in the near-field of the grating waveguide structure, the absorption being the imaginary part of the refractive index. The mathematical/physical methods for the calculation of the effect of an absorption at a certain wavelength on the refractive index, as a function of the wavelength, are known from literature.

Characteristic for a further modification of the method according to the invention is, that one or more luminescences, excited in the evanescent field of an excitation light guided in layer (a), are determined in addition to the locally resolved determination of changes of the resonance conditions for the incoupling of an excitation light into the layer (a) of a grating waveguide structure according to the invention or for the outcoupling of a light guided in said layer (a).

This advancement, as a combined imaging method of a locally (laterally) resolved determination of the effective refractive index and of a locally resolved luminescence measurement, allows, for example, to determine the binding of a ligand as an analyte to an immobilized biological or biochemical or synthetic recognition element as a receptor in one or more measurement areas is determined from the local change of the effective refractive index and a functional response of said ligand receptor system is determined from a change of a luminescence emanating from said measurement areas.

Said receptor-ligand system can, for example, be a transmembrane receptor protein whereto binds a corresponding ligand contained in a supplied sample. For example, a functional response of this receptor-ligand system can consist of the opening of an ion channel, resulting in a local change of the pH or/and of the ion concentration. Such a local change can, for example, occur upon use of a luminescent dye with a pH-dependent or/and ion-dependent luminescence intensity and/or spectral emission.

This combined measurement method according to the invention also allows, for example, to determine the density of immobilized biological or biochemical or synthetic recognition elements as receptors in one or more measurement areas is determined from the differences between the resonance conditions for the incoupling of an excitation light into the layer (a) of the grating waveguide structure or for the outcoupling of a light guided in said layer (a), in the region of said measurement areas, and the corresponding resonance conditions in the environment, i..e. outside of said measurement areas, and wherein the binding of a ligand as an analyte to said recognition elements is determined from a change of a luminescence emanating from said measurement areas.

Thereby it is possible that (firstly) the isotropically emitted luminescence or (secondly) luminescence that is incoupled into the optically transparent layer (a) and out-coupled by a grating structure (c) or luminescence comprising both parts (firstly and secondly) is measured simultaneously.

For the generation of said luminescence, a luminescent dye or a luminescent nano-particle can be used as a luminescence label in the method according to the invention, wherein said luminescence label can be excited and emits at a wavelength between 300 nm and 1100 nm.

The luminescence or fluorescence labels can be conventional luminescence or fluorescence dyes or also so-called luminescent or fluorescent nanoparticles based on semi-conductors (W. C. W. Chan and S. Nie, “Quantum dot bioconjugates for ultrasensitive nonisotopic detection”, Science 281(1998)2016-2018).

The mass label and/or the luminescence label can be bound to the analyte or, in a competitive assay, to an analyte analogue or, in a multi-step assay, to one of the binding partners of the immobilized biological or biochemical or synthetic recognition elements or to the biological or biochemical or synthetic recognition elements.

Additionally it can be advantageous, if the one or more determinations of luminescences and/or determinations of light signals at the excitation wavelengths are performed polarization-selective, wherein preferably the one or more luminescences are measured at a polarization that is different from the one of the excitation light.

The method according to the invention and any of the embodiments described above allows a simultaneous or sequential, quantitative or qualitative determination of one or more analytes of the group comprising antibodies or antigens, receptors or ligands, chelators or “histidin-tag components”, oligonucleotides, DNA or RNA strands, DNA or RNA analogues, enzymes, enzyme cofactors or inhibitors, lectins and carbohydrates.

The samples to be examined can be naturally occurring body fluids, such as blood, serum, plasm, lymph or urine or egg yolk.

A sample to be examined can, however, also be an optically turbid liquid, surface water, a soil or plant extracts, or bio- or process broth.

The samples to be examined can also be taken from biological tissue parts.

A further subject of the invention is the use of a grating waveguide structure according to the invention and/or of an optical system according to the invention and/or of an analytical system according to the invention and/or of a method according to the invention and any of the embodiments described above for qualitative and/or quantitative analyses for the determination of chemical, biochemical or biological analytes in screening methods in pharmaceutical research, combinatorial chemistry, clinical and preclinical development, for real-time binding studies and the determination of kinetic parameters in affinity screening and in research, for qualitative and quantitative analyte determinations, especially for DNA- and RNA analytics, for the generation of toxicity studies and the determination of expression profiles, and for the determination of antibodies, antigens, pathogens or bacteria in pharmaceutical product development and research, human and veterinary diagnostics, agrochemical product development and research, for symptomatic and pre-symptomatic plant diagnostics, for patient stratification in pharmaceutical product development and for the therapeutic drug selection, for the determination of pathogens, nocuous agents and germs, especially of salmonella, prions and bacteria, in food and environmental analytics.

The invention shall be explained in more detail and demonstrated by means of the following examples of applications.

### EXAMPLE 1

a) Grating Waveguide Structure

A grating waveguide structure with the external dimensions of 16 mm width×48 mm length×0.7 mm thickness was used. The substrate material (optically transparent layer (b)) consisted of AF 45 glass (refractive index n=1.52 at 633 nm). A continuous structure of a surface relief grating with a period of 360 nm and a depth of 25 +/−5 nm had been generated in the substrate by holographic illumination of the layer (b), followed by etching, with orientation of the grating lines in parallel to the specified width of the sensor platform. The waveguiding, optically transparent layer (a) of Ta₂O₅ on the optically transparent layer (b) had been generated by reactive, magnetic field supported DC-sputtering (see DE 4410258) and had a refractive index of 2.15 at 633 nm (layer thickness 150 nm). Excitation light of 633 nm can be coupled into the layer (a) (and outcoupled) at an angle of about +3° with respect to a line perpendicular to the structure.

As preparation for the immobilization of the biochemical or biological or synthetic recognition elements the grating waveguide structure was cleaned and silanized in the liquid phase with epoxy silane (10 ml (2% v/v) 3-glycidyloxypropyltrimethoxy silane and 1 ml (0.2% v/v) N-ethyldiisopropyl amine in 500 ml ortho-xylol (for 7 hours at 70° C.). Then solutions of 18-mer oligonucleotides (5′-CCGTAACCTCATGATT-3′-NH2) (18*—NH2) were deposited in always two arrays of 16×8 spots (8 rows×16 columns) each (50 pl per spot), using a commercial spotter (Genetic Microsystems 417 Arrayer). The concentration of the deposited solutions was 5×10⁻⁸ M 18*—NH2, resulting in a mass coverage of the generated spots (about 125 μm diameter at a center-to-center distance of 370 μm) as measurement areas of about 600 000 Da/μm², corresponding to about 1 pg/mm².

b) Optical System

A helium-neon laser with an output power of 1.1 mW (Melles-Griot, 05-LHP-901) was used as an excitation light source. The polarization of the laser was oriented in parallel to the grating lines of the grating waveguide structure, for excitation of the TE₀-mode at incoupling conditions. The laser beam was expanded seven times with a beam expansion optics and directed through a diaphragm of 5 mm diameter, in order to discriminate external, weaker fractions of the expanded laser beam and to discriminate exterior diffraction effects. Then the laser light was strongly attenuated using a neutral density filter (ND 4.7), in order to avoid a saturation of the detector during the measurement of the transmitted light fraction. The laser light was directed towards the side of the optically transparent layer (b) (substrate side consisting of AF 45 glass), where the power, after attenuation, was 20 nW.

The grating waveguide structure was mounted on a manually adjustable goniometer, allowing for variation of the incidence angle of the excitation light on the sensor platform, in a plane essentially perpendicular to the optical axis of the excitation light, the grating lines being oriented perpendicular to the projection of the excitation light into the plane of the grating waveguide structure.

A CCD camera (Ultra Pixx 0401E, Astrocam, Cambridge, UK) with Peltier cooling, equipped with a Kodak CCD-chip KAF 0401 E-1, was used as a locally resolving detector. For locally (laterally) resolved determination of the transmitted light, after passing of the excitation light through the optically transparent waveguiding layer (a), the camera was adjusted in such a way, that the transmitted light impinged essentially perpendicular onto the entrance lens of the camera.

c) Measurement Method and Results

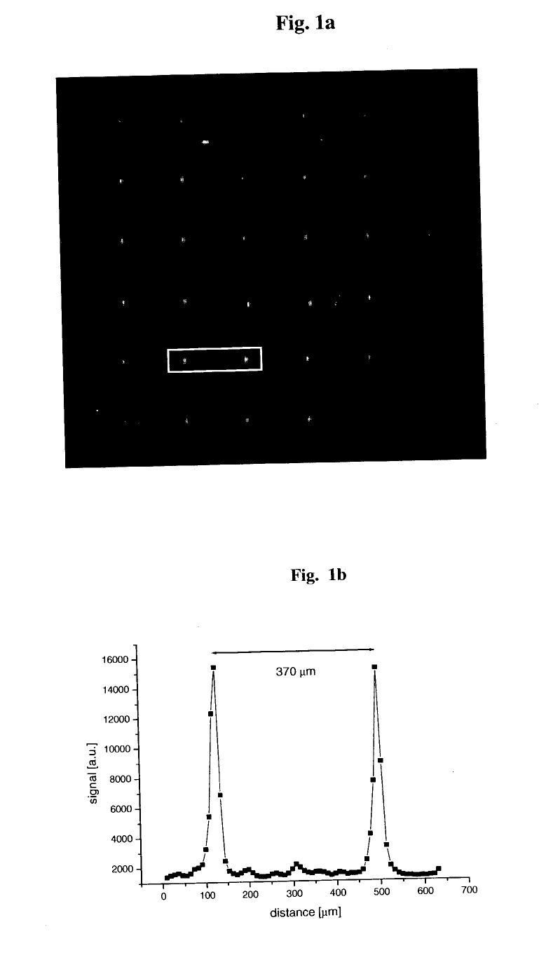

The measurement process was performed in air, without using additional sample compartments or additionally supplied reagents. The fulfillment of the resonance condition on the regions of the grating waveguide structure free from measurement areas (not being measurement areas) is monitored by the almost complete disappearance of the transmitted light (FIG. 1a), whereby, at the same measurement conditions, unfulfilment of the resonance condition in the measurement areas is monitored by a transmission signal significantly increased there (FIG. 1a and FIG. 1b with a linear cross-section of the signals from two measurement areas): The strong contrast and the high local (lateral) resolution are very surprising, as well as the observation to be made from FIG. 1b, that an inhomogeneous mass coverage within a measurement area (to be expected based on the applied method of deposition) with maximum mass coverage about in the center of the measurement area, can be resolved with this measurement method. Also very surprising is the extraordinarily high sensitivity allowing to distinguish the differences in mass coverage (between the regions of the spots and the surrounding regions), of 1 pg/mm², with an excellent contrast.

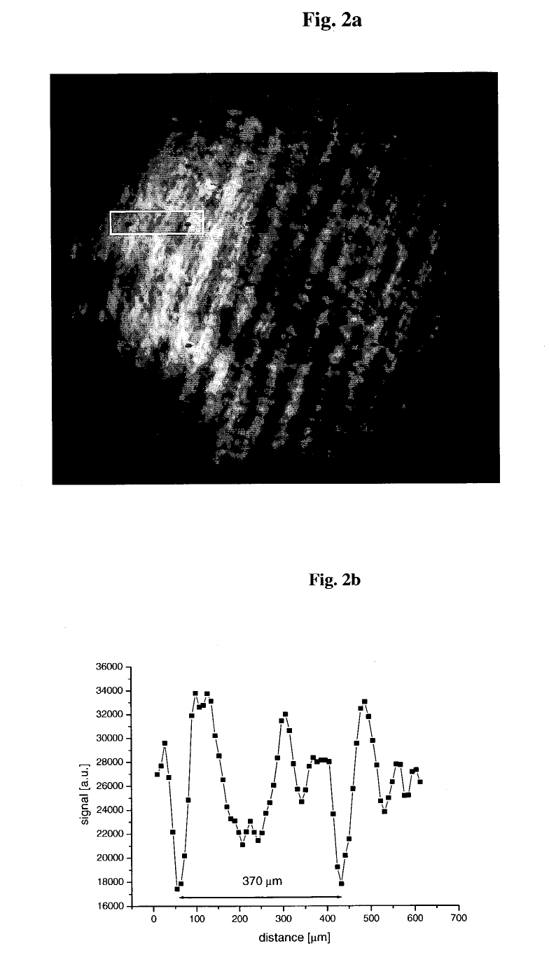

Furtheron, it was surprisingly found that the matching of the coupling angle to the satisfaction of the resonance condition can also be observed by means of the local minima of light transmission (FIG. 2a and 2b; the two spots are indicated in the figures by the annotation of their distance “370 μm”). This observation is surprising, because the optical system was not at all optimized for this measurement, as evident from the interfering strong diffraction effects observable in FIG. 2a. (These interfering diffraction effects are not caused by physical effects of the grating waveguide structure according to the invention nor by the optical system according to the invention, but by the provisional character of the used set-up).

### EXAMPLE 2

a) Grating Waveguide Structure

A grating waveguide structure with the external dimensions of 16 mm width×48 mm length x 0.7 mm thickness was used. The substrate material (optically transparent layer (b)) consisted of AF 45 glass (refractive index n=1.52 at 633 nm). Again, a continuous structure of a surface relief grating with a period of 360 nm and s depth of 25 nm had been generated in the substrate, with orientation of the grating lines in parallel to the specified width of the sensor platform. The subsequently deposited waveguiding, optically transparent layer (a) of Ta₂O₅ on the optically transparent layer (b) had a refractive index of 2.137 at 532 nm (layer thickness 150 nm). Excitation light of 532 nm can be coupled into the layer (a) (and outcoupled) at an angle of about +14.3° with respect to a line perpendicular to the structure.

As preparation for the immobilization of the biochemical or biological or synthetic recognition elements the grating waveguide structure was cleaned. Then solutions of NeutrAvidin™ were deposited on the cleaned tantalum pentoxide surface in an array of 3×3 spots (3 rows×3 columns) (500 pl per spot), using a commercial spotter (GeSIM). Thereby, the concentration of the deposited solutions was 1.7×10⁻⁵ M NeutrAvidin™, resulting in a mass coverage of the generated spots (about 430 μm diameter at a center-to-center distance of 1 mm) as measurement areas of about 4 ng/mm².

b) Optical System

A diode-pumped, frequency-doubled NdYag laser with an output power of 10 mW (Laser 2000) was used as an excitation light source. The polarization of the laser was oriented perpendicular to the grating lines of the grating waveguide structure, for excitation of the TM₀-mode at incoupling conditions. The laser beam was expanded seven times with a beam expansion optics and directed through a slit of 4 mm width, in order to discriminate external, weaker fractions of the expanded laser beam and to discriminate exterior diffraction effects. The laser light was directed towards the side of the optically transparent layer (b) (substrate side consisting of AF 45 glass).

The grating waveguide structure was mounted on a manually adjustable goniometer, allowing for variation of the incidence angle of the excitation light on the sensor platform, in such a way, that the grating lines were oriented perpendicular to the projection of the excitation light into the plane of the grating waveguide structure. A piece of very fine white paper of low granularity was mounted as a projection screen at the opposite side of the grating waveguide structure, with respect to the irradiated excitation light, for generation of an image of the transmitted excitation light. As the optical path of the transmitted excitation light was almost perfectly parallel, the distance between the projection screen and the grating waveguide structure oriented essentially in parallel to it could be chosen according to convenience over a wide range, without significant loss of contrast or distortions of the contours.

A CCD camera (Ultra Pixx 0401E, Astrocam, Cambridge, UK) with Peltier cooling, equipped with a Kodak CCD-chip KAF 0401 E-1, was used as a locally resolving detector. For locally (laterally) resolved determination of the transmitted excitation light, by recording the image on the described projection screen, and/or for the collection of the scattered light of an excitation light guided in layer (a) after incoupling by means of a grating structure (c) and/or for the collection of the light outcoupled again essentially in parallel to the reflected light, the camera was mounted at the same side of the grating waveguide structure, with respect to the direction of irradiation of the excitation light.

c) Measurement Method and Results

The measurement process was performed in air, without using additional sample compartments or additionally supplied reagents. Thereby, a difference in coupling angle of 0.124° for fulfilment of the resonance condition for incoupling into the layer (a), between incoupling on the measurement areas and incoupling on the uncoated regions of the grating structure, was determined.

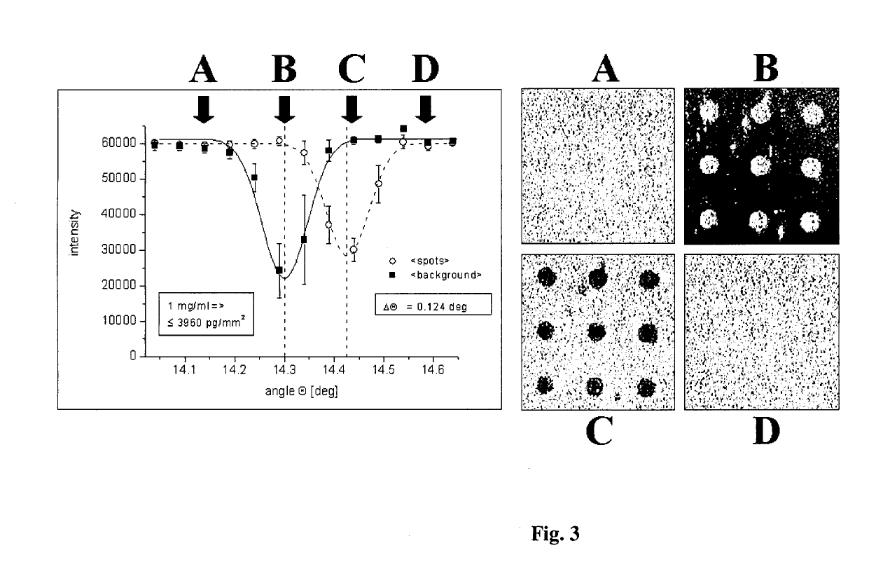

The results of the measurement method for the locally (laterally) resolved measurement of the transmitted excitation light, by recording of the images on said projection screen and positioning of the camera at the same side of the grating waveguide structure, with respect to the irradiated excitation light, are shown in FIG. 3.

Again, the fulfilment of the resonance condition on the regions of the grating waveguide structure free from measurement areas (not being measurement areas) is monitored by the almost complete disappearance of the transmitted light (at an angle of 14.3°, left part of FIG. 3 and FIG. 3B), whereas, under the same conditions, unfulfilment of the resonance condition in the measurement areas is monitored by a transmission signal increased by a factor of 3 (FIG. 3B and left part of FIG. 3B).

FIG. 3C shows the reversed situation, i.e. fulfilment of the resonance condition for incoupling of light into the layer (a) in the region of the measurement areas (at an angle of 14.424°, see Fif. 3, left), resulting in minimum transmission of light in the region of the measurement areas at this angle, and unfulfilment of the resonance condition in the residual regions, resulting in maximum transmission. It is obvious from FIG. 3C, from observable concentric brighter regions, recognizable as dotted lines of close to circular contour within and close to the external borders of the measurement areas appearing dark, that also under these conditions (with excitation of transversally magnetically polarized modes) the local (lateral) resolution is well below the spot diameter: The regions of different brightness within the spots monitor geometrical inhomogeneities of the amounts of locally adsorbed or immobilized proteins respectively recognition elements. The appearance of such inhomogeneities upon the fabrication of arrays of immobilized recognition elements is known from the specialized literature.—When using transversally electrically polarized instead of transversally magnetically polarized excitation light of the same wavelength and for the same sensor platform, (not graphically illustrated), the capability of high local (lateral) resolution was observed in a still more pronounced manner.

### EXAMPLE 3

Homogeneity of the Resonance Angle for Incoupling or Outcoupling of Light on an Area Corresponding to an Array of Measurement Areas

A grating waveguide structure (with a grating modulated over its whole surface) with similar given layer and grating parameters as in Example 1.a is used. The variation of the coupling angle in x- and y-direction (x: perpendicular to the grating lines; y: in parallel to the grating lines) shall be investigated on a surface of 5 mm×5 mm, corresponding to a typical base area of an array of measurement areas to be generated optionally on such a structure.

The parallel excitation light beam from a helium-neon laser (633 nm, 0.8 mm beam diameter) is directed under an angle close to the resonance angle for incoupling of light into the layer (a) of the structure. The incidence angle is varied in small steps (step interval for example 0.02°) in an angular range from about 1° above and below the resonance angle. Thereby, at each step, the intensity of the scattered light of the light guided in the layer (a) after incoupling by the grating structure is collected as a lens system and focused onto a photomultiplier as an integrating, locally (laterally) not resolving detector. The size of the area of the grating waveguide structure imaged onto the detector can be limited by diaphragm (in this example of a circular hole of 1 mm diameter) located in the plane of the intermediate image, especially for avoiding undesired effects of scattered light. The optimum adjustment for satisfaction of the resonance condition for the incoupling of light into layer (a) is monitored by a maximum value of Iᵣ. Additionally, the halfwidth of the corresponding resonance curves can be determined from the resonance curves of Iᵣ as a function of the coupling angle.

The measurement method described above was performed for 25 (5×5) measurement positions on the specified area of the grating waveguide structure, each located at a distance (center-to-center) of 1 mm (measurement interval A=1 mm). The resonance angles determined for the different measurement positions in the defined x/y pitch are summarized in Table 1. The deviation from the average value of the resonance angle (2.15° in this example) is not more than 0.06° on the whole area.

TABLE 1
Variability of the resonance angle for optimum incoupling and
outcoupling of light on a quadratic area of 5 mm × 5 mm on a
grating waveguide structure (for generation of the measurement
areas located thereon).

| Measurement | | | | | |
|---|---|---|---|---|---|
| Position No. | | | | | |
| y-direction | x-direction (interval Δ = 1 mm) | | | | |
| (Δ = 1 mm) | 1 | 2 | 3 | 4 | 5 |
| 1 | 2.15 | 2.09 | 2.19 | 2.25 | 2.11 |
| 2 | 2.13 | 2.11 | 2.19 | 2.21 | 2.13 |
| 3 | 2.15 | 2.13 | 2.19 | 2.25 | 2.15 |
| 4 | 2.09 | 2.11 | 2.21 | 2.19 | 2.13 |
| 5 | 2.07 | 2.13 | 2.19 | 2.09 | 2.15 |

1. Grating waveguide structure for the locally resolved determination of changes of the resonance conditions for the incoupling of an excitation light into a waveguide or for the outcoupling of a light guided in the waveguide, comprising an array of at least two or more, laterally separated measurement areas (d) on said platform, comprising a stratified optical waveguide
with a first optically transparent layer (a) on a second optically transparent layer (b) with lower refractive index than layer (a),
with one or more grating structures (c) for the incoupling of an excitation light towards the measurement areas (d) or for the outcoupling of a light guided in layer (a) in the region of the measurement areas
with at least one or more laterally separated measurement areas (d) on said one or more grating structures (c)
with equal or different biological or biochemical or synthetic recognition elements (e) immobilized on said measurement areas, for the qualitative and/or quantitative determination of one or more analytes in a sample brought into contact with said measurement areas,
wherein said excitation light is irradiated simultaneously onto said array of measurement areas, and the degree of satisfaction of the resonance condition for the incoupling of light into the layer (a) towards said two or more measurement areas is simultaneously measured and a cross-talk of excitation light guided in layer (a), from one measurement area to one or more adjacent measurement areas is prevented by outcoupling said excitation light again by means of the grating structure (c).

2. Grating waveguide structure for the locally resolved determination of changes of the resonance conditions for the incoupling of an excitation light into a waveguide or for the outcoupling of a light guided in the waveguide, comprising a two-dimensional array of at least four or more, laterally separated measurement areas (d) on said platform, comprising a stratified optical waveguide
with a first optically transparent layer (a) on a second optically transparent layer (b) with lower refractive index than layer (a),
with one or more grating structures (c) for the incoupling of an excitation light towards the measurement areas (d) or for the outcoupling of a light guided in layer (a) in the region of the measurement areas
with at least one or more laterally separated measurement areas (d) on said one or more grating structures (c)
with equal or different biological or biochemical or synthetic recognition elements (e) immobilized on said measurement areas, for the qualitative and/or quantitative determination of one or more analytes in a sample brought into contact with said measurement areas,
wherein the density of the measurement areas on a common grating structure (c) is at least 10 measurement areas per square centimeter, said excitation light is irradiated simultaneously onto said array of measurement areas, and the degree of satisfaction of the resonance condition for the incoupling of light into the layer (a) towards said two or more measurement areas is simultaneously measured and a cross-talk of excitation light guided in layer (a), from one measurement area to one or more adjacent measurement areas is prevented by outcoupling said excitation light again by means of the grating structure (c).

3. Grating waveguide structure according to any of claims 1-2, wherein a continuously modulated grating structure (c) extends essentially over the whole area of said grating waveguide structure.

4. Grating waveguide structure according to any of claims 1-3, wherein the lateral resolution for the determination of the degree of satisfaction of the resonance condition for incoupling of light into layer (a) is better than 200 μm.

5. Grating waveguide structure according to any of claims 1-4, wherein the lateral resolution for the determination of the degree of satisfaction of the resonance condition for incoupling of light into layer (a) is better than 20 μm.

6. Grating waveguide structure according to any of claims 1-5, wherein the lateral resolution for the determination of the degree of satisfaction of the resonance condition for incoupling of light into layer (a) can be improved by choice of a larger modulation depth of grating structures (c) or decreased by choice of a lower modulation depth of said grating structures.

7. Grating waveguide structure according to any of claims 1-6, wherein the halfwidth of the resonance angle for satisfaction of the resonance condition for incoupling of light into layer (a) can be decreased by a decrease of the modulation depth of grating structures (c) or increased by an increase of the modulation depth of said grating structures.

8. Grating waveguide structure according to any of claims 1-7, wherein, outside from the measurement areas, the resonance angle for incoupling or outcoupling of a monochromatic excitation light varies by no more than 0.1° (as deviation from an average value) within an area of at least 4 mm² (with orientation of the area boundaries in parallel or not in parallel to the lines of the grating structure (c)).

9. Grating waveguide structure according to any of claims 1-8, wherein the degree of satisfaction of the resonance condition for incoupling of light into layer (a) towards the measurement areas is determined (1) from the intensity of the outcoupled excitation light, outcoupled essentially in parallel to the reflected light (i.e. of the sum of both parts) or (2) from the intensity of the transmitted excitation light or (3) from the intensity of the scattered light of excitation light guided in layer (a) after incoupling by means of a grating structure (c), or from any combination of light components (1) to (3).

10. Grating waveguide structure according to any of claims 1-9, wherein (1) the sum of the intensities of the reflected light and of the excitation light outcoupled essentially in parallel thereto or (2) the intensity of scattered light of excitation light guided in layer (a) after incoupling by means of a grating structure (c) or (3) a combination of said light intensities (1) and (2) shows a maximum upon local satisfaction of the resonance condition for incoupling of light into layer (a) in the region of said local measurement area.

11. Grating waveguide structure according to any of claims 1-10, wherein the intensity of the transmitted excitation light shows a mimimum upon local satisfaction of the resonance condition for incoupling of light into layer (a) in the region of said local measurement area.

12. Grating waveguide structure according to any of claims 1-11, wherein a further optically transparent layer (b′) with lower refractive index than layer (a) and a thickness between 5 nm and 10000 nm, preferably of 10 nm-1000 nm, is provided between layers (a) and (b) and in contact with layer (a).

13. Grating waveguide structure according to any of claims 1-12, wherein an adhesion-promoting layer (f), with a thickness of preferably less than 200 nm, more preferably of less than 20 nm, is deposited on the optically transparent layer (a), for immobilization of biological or biochemical or synthetic recognition elements, and wherein the adhesion-promoting layer preferably comprises chemical compounds of the group comprising silanes, epoxides, functionalized, charged or polar polymers and “self-organized functionalized monolayers”.

14. Grating waveguide structure according to any of claims 1-13, wherein laterally separated measurement areas (d) are generated by laterally selective deposition of biological or biochemical or synthetic recognition elements on said grating waveguide structure, preferably using a method of the group of methods comprising ink jet spotting, mechanical spotting, micro contact printing, fluidic contacting of the measurement areas with the biological or biochemical or synthetic recognition elements upon their supply in parallel or crossed micro channels, upon application of pressure differences or electric or electromagnetic potentials.

15. Grating waveguide structure according to claim 14, wherein, as biological or biochemical or synthetic recognition elements, components of the group comprising nucleic acids (DNA, RNA, oligonucleotides) and nucleic acid analogues (e.g. PNA), antibodies, aptamers, membrane-bound and isolated receptors, their ligands, antigens for antibodies, “histidin-tag components”, cavities generated by chemical synthesis, for hosting molecular imprints. etc., are deposited, or wherein whole cells or cell fragments are deposited as biological or biochemical or synthetic recognition elements.

16. Grating waveguide structure according to any of claims 14-15, wherein compounds which are “chemically neutral” towards the analyte, preferably of the groups comprising, for example, albumines, especially bovine serum albumine or human serum albumine, fragmentated natural or synthetic DNA, such as from herring or salmon sperm, not hybridizing with polynuleotides to be analyzed, or uncharged but hydrophilic polymers, such as polyethyleneglycols or dextranes, are deposited between the laterally separated measurement areas (d).

17. Grating waveguide structure according to any of claims 1-16, wherein up to 1,000,000 measurement areas are provided in a 2-dimensional arrangement and wherein a single measurement area has an area of 0.001 mm²-6 mm².

18. Grating waveguide structure according to any of claims 1-17, wherein a multitude of measurement areas is provided at a density of more than 10, preferably of more than 100, most preferably of more than 1000 measurement areas per square centimeter on a common grating structure (c).

19. Grating waveguide structure according to any of claims 1-18, wherein the exterior dimensions of its footprint are similar to the footprint of standard microtiter plates of about 8 cm×12 cm (with 96 or 384 or 1536 wells).

20. Grating waveguide structure according to any of claims 1-19, wherein grating structures (c) are diffractive gratings with a common period or multidiffractive gratings.

21. Grating waveguide structure according to any of claims 1-7 or 10-19, wherein one or more grating structures (c) have a laterally varying periodicity essentially perpendicular to the direction of propagation of the exciataion light incoupled into the optically transparent layer (a).

22. Grating waveguide structure according to any of claims 1-21, wherein the material of the second optically transparent layer (b) comprises quartz, glass, or transparent thermoplastic plastics of the group comprising, for example, poly carbonate, poly imide, or poly methylmethacrylate.

23. Grating waveguide structure according to any of claims 1-22, wherein the refractive index of the first optically transparent layer (a) is higher than 1.8

24. Grating waveguide structure according to any of claims 1-23, wherein the first optically transparent layer (a) comprises a material of the group comprising TiO₂, ZnO, Nb₂O₅, Ta₂O₅, HfO₂, or ZrO₂, especially preferably comprising TiO₂, Nb₂O₅, or Ta₂O₅.

25. Grating waveguide structure according to any of claims 1-24, wherein the product of the thickness of the first optically transparent layer (a) and its refractive index is one tenth to a whole, preferably one third to two thirds, of the excitation wavelength of an excitation light to be incoupled into the layer (a).

26. Grating waveguide structure according to any of claims 1-25, wherein the grating (c) has a period of 200 nm-1000 nm and the modulation depth of the grating (c) is 3 nm-100 nm, preferably of 5 nm-30 nm.

27. Grating waveguide structure according to claim 25, wherein the ratio of the modulation depth to the thickness of the first optically transparent layer (a) is equal or smaller than 0.2.

28. Grating waveguide structure according to any of claims 1-27, wherein the grating structure (c) is a relief grating with a rectangular, triangular or semi-circular profile or a phase or volume grating with a periodic modulation of the refractive index in the essentially planar, optically transparent layer (a).

29. Grating waveguide structure according to any of claims 1-28, wherein optically or mechanically recognizable marks for simplifying adjustments in an optical system and/or for the connection to sample compartments as part of an analytical system are provided on it.

30. Optical system for the locally resolved determination of changes of the resonance conditions for the incoupling of an excitation light into a waveguide or for the outcoupling of a light guided in the waveguide, comprising an array of at least two or more, laterally separated measurement areas (d) on said platform, comprising
at least one excitation light source
a grating waveguide structure according to any of claims 1-29
at least one locally resolving detector for determination of the transmitted excitation light located at the opposite side of the grating waveguide structure, with respect to the irradiated excitation light, and/or for the determination of the light outcoupled again essentially in parallel to the reflected light at the same side of the grating waveguide structure, with respect to the direction of irradiation of the excitation light, and/or for the determination of the scattered light of an excitation light guided in layer (a) after incoupling by means of a grating structure (c).

31. Optical system for the locally resolved determination of changes of the resonance conditions for the incoupling of an excitation light into a waveguide or for the outcoupling of a light guided in the waveguide, comprising an array of at least two or more, laterally separated measurement areas (d) on said platform, comprising
at least one excitation light source
a grating waveguide structure according to any of claims 1-29
at least one diffusively reflecting and/or diffusively transmitting projection screen located at the opposite side of the grating waveguide structure, with respect to the direction of irradiation of the excitation light, for generation of an image of the transmitted excitation light,
and at least one locally resolving detector for collection of the image of the transmitted excitation light from said projection screen.

32. Optical system according to claim 31, wherein said at least one locally resolving detector for collection of the image of the transmitted excitation light from said projection screen is located at the same side of the grating waveguide structure, with respect to the direction of irradiation of the excitation light.

33. Optical system according to claim 31, wherein said at least one locally resolving detector for collection of the image of the transmitted excitation light from said projection screen is located at the side of the transmitted excitation light, i.e. at the opposite side of the grating waveguide structure with respect to the direction of irradiation of the excitation light, whereby said projection screen is at least partially transmittant.

34. Optical system with a grating waveguide structure according to claim 21, wherein no more than measurement area is provided on each grating structure (c) with a periodicity locally varying essentially perpendicular to the direction of propagation of the excitation light incoupled into layer (a), and wherein an unstructured area of the grating waveguide structure is provided in direction of propagation of the excitation light to be incoupled into and guided in layer (a), and wherein optionally a further grating structure (c) is provided in direction of the further propagation of the excitation light guided in layer (a), which is used to outcouple said guided excitation light towards a locally resolving detector.

35. Optical system according to claim 34, wherein changes of the mass coverage upon adsorption or desorption of molecules at the measurement areas on grating structures (c) result in a shift, essentially in parallel to the grating lines, of the local position of satisfaction of the resonance condition for the incoupling of the excitation light into layer (a) by means of said grating structure (c).

36. Optical system according to any of claims 34-35, wherein a one-dimensional arrangement of at least two grating structures (c) according to claim 21 is irradiated simultaneously with excitation light.

37. Optical system according to any of claims 34-36, wherein the excitation light is irradiated essentially in parallel and is essentially monochromatic.

38. Optical system according to claim 37, wherein the excitation light is irradiated linearly polarized, for excitation of a TE₀ or TM₀-mode guided in the layer (a).

39. Optical system according to any of claims 37-38, wherein a two-dimensional arrangement of at least four grating structures (c) according to claim 21 is irradiated simultaneously with excitation light.

40. Optical system for the locally resolved determination of changes of the resonance conditions for the incoupling of an excitation light into a waveguide or for the outcoupling of a light guided in the waveguide, comprising a two-dimensional array of at least four or more, laterally separated measurement areas (d) on said platform, comprising
at least one excitation light source
a grating waveguide structure according to any of claims 1-29
a positioning element for the change of the angle of incidence of the excitation light on the grating waveguide structure
at least one locally resolving detector for determination of the transmitted excitation light located opposite side of the grating waveguide structure, with respect to the irradiated excitation light, and/or for the determination of the light outcoupled again essentially in parallel to the reflected light at the same side of the grating waveguide structure, with respect to the direction of irradiation of the excitation light, and/or for the determination of the scattered light of an excitation light guided in layer (a) after incoupling by means of a grating structure (c).

41. Optical system for the locally resolved determination of changes of the resonance conditions for the incoupling of an excitation light into a waveguide or for the outcoupling of a light guided in the waveguide, comprising a two-dimensional array of at least four or more, laterally separated measurement areas (d) on said platform, comprising
at least one excitation light source
a grating waveguide structure according to any of claims 1-29
a positioning element for the change of the angle of incidence of the excitation light on the grating waveguide structure
a diffusively reflecting and/or diffusively transmitting projection screen located at the opposite side of the grating waveguide structure, with respect to the direction of irradiation of the excitation light, for generation of an image of the transmitted excitation light, and at least one locally resolving detector for collection of the image of the transmitted excitation light from said projection screen.

42. Optical system for the locally resolved determination of changes of the resonance conditions for the incoupling of an excitation light into a waveguide or for the outcoupling of a light guided in the waveguide, comprising an array of at least two or more, laterally separated measurement areas (d) on said platform, comprising
at least one excitation light source tunable over a certain spectral range
a grating waveguide structure according to any of claims 1-29
at least one locally resolving detector for determination of the transmitted excitation light located at the same side of the grating waveguide structure, with respect to the irradiated excitation light, and or for the determination of the light outcoupled again essentially in parallel to the reflected light at the same side of the grating waveguide structure, with respect to the direction of irradiation of the excitation light, and/or for the determination of the scattered light of an excitation light guided in layer (a) after incoupling by means of a grating structure (c).

43. Optical system according to claim 42, wherein said at least one tunable light source is tunable over a spectral range of at least 5 nm.

44. Optical system for the locally resolved determination of changes of the resonance conditions for the incoupling of an excitation light into a waveguide or for the outcoupling of a light guided in the waveguide, comprising an array of at least two or more, laterally separated measurement areas (d) on said platform, comprising
at least one excitation light source polychromatic within a certain spectral range
a grating waveguide structure according to any of claims 1-29
at least one locally resolving detector for determination of the transmitted excitation light located at the same side of the grating waveguide structure, with respect to the irradiated excitation light, and/or for the determination of the light outcoupled again essentially in parallel to the reflected light at the same side of the grating waveguide structure, with respect to the direction of irradiation of the excitation light, and/or for the determination of the scattered light of an excitation light guided in layer (a) after incoupling by means of a grating structure (c).

45. Optical system according to claim 44, wherein said at least one polychromatic emission light source has an emission bandwith of at least 5 nm.

46. Optical system according to any of claims 44-45, wherein a spectrally selective optical component of high spectral resolution in said certain spectral range is located in the optical path between the grating waveguide structure and the at least one locally resolving detector.

47. Optical system according to claim 46, wherein said spectrally selective component is suitable for the generation of spectrally selective, locally resolved, two-dimensional illustrations of the intensity distributions of the measurement light emanating from the grating waveguide structure, at different wavelengths within said certain spectral range.

48. Optical system according to any of claims 44-47, wherein the locally resolved determination of changes of the resonance conditions for incoupling of an excitation light into layer (a) or outcoupling of light guided in the waveguide (layer (a)), from said polychromatic light source in the region of the measurement areas, is performed
by simultaneous or sequential collection of the transmitted excitation light and/or
by simultaneous or sequential collection of the light outcoupled again essentially in parallel to the reflected light at the same side of the grating waveguide structure, with respect to the side of irradiation of the excitation light and/or
by simultaneous or sequential collection of scattered light of excitation light guided in the layer (a) after incoupling by means of a grating waveguide structure (c),
by means of spectrally selective detection, within said certain spectral range, using at least one locally resolving detector, preferably under irradiation of the excitation light onto the grating waveguide structure at a constant angle of incidence.

49. Optical system according to any of claims 40-48, wherein the excitation light is irradiated essentially in parallel.

50. Optical system according to any of claims 40-43, wherein the irradiated excitation light is essentially monochromatic.

51. Optical system according to any of claims 40-50, wherein the excitation light is irradiated linearly polarized, for excitation of a TE₀ or TM₀-mode guided in the layer (a).

52. Optical system according to any of claims 40-51, wherein the locally resolved determination of changes of the resonance conditions for incoupling of an excitation light into layer (a) or outcoupling of light guided in the waveguide (layer (a)), in the region of the measurement areas, is performed
by sequential collection of the transmitted excitation light and/or
by sequential collection of the light outcoupled again essentially in parallel to the reflected light at the same side of the grating waveguide structure, with respect to the side of irradiation of the excitation light and/or
by sequential collection of scattered light of excitation light guided in the layer (a) after incoupling by means of a grating waveguide structure (c),
by means of one or more locally resolving detectors upon variation of the angle of incidence of the excitation light irradiated onto the grating waveguide structure.

53. Optical system according to any of claims 42-51, wherein the locally resolved determination of changes of the resonance conditions for incoupling of an excitation light into layer (a) or outcoupling of light guided in the waveguide (layer (a)), in the region of the measurement areas, is performed
by sequential collection of the transmitted excitation light and/or
by sequential collection of the light outcoupled again essentially in parallel to the reflected light at the same side of the grating waveguide structure, with respect to the side of irradiation of the excitation light and/or
by sequential collection of scattered light of excitation light guided in the layer (a) after incoupling by means of a grating waveguide structure (c),
by means of one or more locally resolving detectors upon variation of the emission wavelength of a tunable light source, preferably upon irradiating the excitation light onto the grating waveguide structure at constant angle of incidence.

54. Optical system according to any of claims 30-53, wherein the excitation light from at least one light source is expanded as homogeneously as possible to an essentially light ray bundle by means of an expansion optics and irradiated onto the one or more measurement areas.

55. Optical system according to claim 54, wherein the irradiated excitation light bundle has, at least in one dimension, a diameter of at least 2 mm, preferably of at least 10 mm.

56. Optical system according to any of claims 30-52, wherein the excitation light from the at least one light source is multiplexed to a plurality of individual rays of intensity as uniform as possible by a diffractive optical element, or in case of multiple light sources by multiple diffractive optical elements, which are preferably Dammann gratings, or by refractive optical elements, which are preferably microlens arrays, the individual rays being launched essentially parallel to each other onto laterally separated measurement areas.

57. Optical system according to any of claims 30-39, wherein the excitation light from at least one, preferably monochromatic light source is expanded to a ray bundle of intensity as homogeneous as possible, with a slit-type cross-section (in a plane perpendicular to the optical axis of the optical ray path), the main axis being oriented in parallel to the grating lines, by means of a beam shaping optics, wherein the individual rays of the ray bundle are essentially in parallel to each other in a plane of projection in parallel to the plane of the grating waveguide structure, and wherein said ray bundle has a convergence or divergence with a certain convergence or divergence angle in a plane perpendicular to the plane of the grating waveguide structure.

58. Optical system according to claim 57, wherein the locally resolved determination of changes of the resonance conditions for incoupling of an excitation light into layer (a) or outcoupling of light guided in the waveguide (layer (a)), in the region of the measurement areas, within an irradiated region of slit-type cross-section, is performed
by simultaneous collection of the transmitted excitation light and/or
by simultaneous collection of the light outcoupled again essentially in parallel to the reflected light at the same side of the grating waveguide structure, with respect to the side of irradiation of the excitation light and/or
by simultaneous collection of scattered light of excitation light guided in the layer (a) after incoupling by means of a grating waveguide structure (c),
by means of one or more locally resolving detectors, wherein the local change of the resonance conditions in a measurement area is monitored
by a shift of the intensity maximum of the light emanating essentially in parallel to the reflected light from said measurement area and
by a shift of the intensity maximum of the scattered light of excitation light guided in the layer (a) after incoupling by means of a grating waveguide structure (c) and
by a shift of the intensity minimum of the light transmitted in the region of said measurement area
(in each case at the condition of satisfaction of the resonance conditions in said measurement area),
wherein the shift of said intensity maximum respectively intensity minimum occurs in a plane in parallel to the plane of the grating waveguide structure, perpendicular to the grating lines.

59. Optical system according to any of claims 30-58, wherein two or more coherent light sources with equal or different emission wavelength are used as excitation light sources.

60. Optical system according to claim 59, wherein the excitation light of two or more coherent light sources is irradiated simultaneously or sequentially from different directions onto a grating structure (c), which is provided as superposition of grating structures with different periodicity.

61. Optical system according to any of claims 30-60, wherein a laterally resolving detector of the group comprising, for example, CCD cameras, CCD chips, photodiode arrays, avalanche diode arrays, multichannel plates and multichannel photomultipliers, is used for signal detection.

62. Optical system according to any of claims 30-61, wherein optical components of the group comprising lenses or lens systems for the shaping of the transmitted light bundles, planar or curved mirrors for the deviation and optionally additional shaping of the light bundles, prisms for the deviation and optionally spectral separation of the light bundles, dichroic mirrors for the spectrally selective deviation of parts of the light bundles, neutral density filters for the regulation of the transmitted light intensity, optical filters or monochromators for the spectrally selective transmission of parts of the light bundles, or polarization selective elements for the selection of discrete polarization directions of the excitation or luminescence light are located between the one or more excitation light sources and the grating waveguide structure according to any of claims 1-29 and/or between said grating waveguide structure and the one or more detectors.

63. Optical system according to any of claims 30-62, wherein the excitation light is launched in pulses with a duration of 1 fsec to 10 min and the emission light from the measurement areas is measured time-resolved.

64. Optical system according to any of claims 30-63, wherein launching of the excitation light and detection of the light emanating from the one or more measurement areas is performed sequentially for one or more measurement areas.

65. Optical system according to claim 64, wherein sequential excitation and detection is performed using movable optical components of the group comprising mirrors, deviating prisms, and dichroic mirrors.

66. Optical system according to any of claims 64-65, wherein the grating waveguide structure is moved between steps of sequential excitation and detection.

67. Optical system for the locally resolved determination of changes of the resonance conditions for the incoupling of excitation light into a waveguide or outcoupling of a light guided in said waveguide, with an array of at least two or more measurement areas (d) on said platform, for the determination of one or more analytes in at least one sample on one or more measurement areas on a grating waveguide structure, with
a grating waveguide structure according to any of claims 1-29
an optical system according to any of claims 30-66 and
supply means for bringing the one or more samples into contact with the measurement areas on the grating waveguide structure.

68. Optical system according to claim 67, wherein said system additionally comprises one or more sample compartments, which are at least in the area of the one or more measurement areas or of the measurement areas combined to segments open towards the grating waveguide structure, wherein the sample compartments each preferably have a volume of 0. 1 nl-100 μl.

69. Optical system according to claim 68, wherein the sample compartments are closed, except for inlet and/or outlet openings for the supply or outlet of samples, at their side opposite to the optically transparent layer (a), and wherein the supply or the outlet of the samples and optionally of additional reagents is performed in a closed flow through system, wherein, in case of liquid supply to several measurement areas or segments with common inlet and outlet openings, these openings are preferably addressed row by row or column by column.

70. Optical system according to any of claims 67-69, wherein compartments for reagents are provided, which reagents are wetted during the assay for the determination of the one or more analytes and contacted with the measurement areas.

71. Method for the qualitative and/or quantitative determination of one or more analytes in one or more samples on at least two or more laterally separated measurement areas on a grating waveguide structure according to any of claims 1-29 in an optical system according to any of claims 34-70, upon determination of changes of the resonance conditions for incoupling of an excitation light into a waveguide or for outcoupling of a light guided in said waveguide, comprising an array of at least two or more laterally separated measurement areas (d) on said grating waveguide structure, wherein the excitation light from at least one excitation light source is irradiated onto a grating waveguide structure (c) with said measurement areas located thereon, and wherein the degree of satisfaction of the resonance condition for the incoupling of light into the layer (a) towards said measurement areas is determined from the signal of at least one locally resolving detector for the collection of the transmitted excitation light and/or for the collection of the light outcoupled again essentially in parallel to the reflected light at the same side of the grating waveguide structure, with respect to the direction of irradiation of the excitation light, and/or for the collection of the scattered light of an excitation light guided in layer (a) after incoupling by means of a grating structure (c).

72. Method for the qualitative and/or quantitative determination of one or more analytes in one or more samples on at least two or more laterally separated measurement areas on a grating waveguide structure according to claim 21, wherein no more than one measurement area is provided on each grating structure (c) with a periodicity locally varying essentially perpendicular to the direction of propagation of the excitation light incoupled into layer (a), and wherein an unstructured region of the grating waveguide structure is provided in direction of further propagation of the excitation light to be incoupled into and guided in layer (a), and wherein optionally a further grating structure (c) is provided in direction of the still further propagation of the excitation light guided in layer (a), which last grating structure is used to outcouple again said guided excitation light towards a locally resolving detector.

73. Method according to claim 72, wherein changes of the local effective refractive index, especially of the mass coverage upon adsorption or desorption of molecules at the measurement areas on grating structures (c), result in a shift, essentially in parallel to the grating lines, of the local position of satisfaction of the resonance condition for the incoupling of the excitation light into layer (a) by means of said grating structure (c).

74. Method according to any of claims 72-73, wherein a one-dimensional arrangement of at least two grating structures (c) according to claim 21 is irradiated simultaneously with excitation light.

75. Method according to any of claims 72-74, wherein the excitation light is irradiated essentially in parallel and is essentially monochromatic.

76. Method according to claim 75, wherein the excitation light is irradiated linearity polarized, for excitation of a TE₀ or TM₀-mode guided in the layer (a).

77. Method according to any of claims 75-76, wherein a two-dimensional arrangement of at least four grating structures (c) according to claim 21 is irradiated simultaneously with excitation light.

78. Method for the qualitative and/or quantitative determination of one or more analytes in one or more samples on at least two or more laterally separated measurement areas on a grating waveguide structure according to any of claims 1-29, upon determination of changes of the resonance conditions for incoupling of an excitation light into a waveguide or for outcoupling of a light guided in said waveguide, comprising a two-dimensional array of at least four or more, laterally separated measurement areas (d) on said platform, wherein
the excitation light from at least one excitation light source is irradiated onto a grating waveguide structure (c) with said measurement areas located thereon, and wherein the degree of satisfaction of the resonance condition for the incoupling of light into the layer (a) towards said measurement areas is determined from the signal of at least one locally resolving detector for the collection of the transmitted excitation light, optionally upon using a diffusively reflecting and/or diffusively transmitting projection screen located at the opposite side of the grating waveguide structure, with respect to the direction of irradiation of the excitation light, for generation of an image of the transmitted excitation light, and/or from the signal of at least one locally resolving detector for the collection of the light outcoupled again essentially in parallel to the reflected light at the same side of the grating waveguide structure, with respect to the direction of irradiation of the excitation light, and/or from the signal of at least one locally resolving detector for the collection of the scattered light of an excitation light guided in layer (a) after incoupling by means of a grating structure (c), and wherein the angle of incidence of the excitation light on the grating waveguide structure is changed by means of a positioning element, resulting, dependent on the local refractive index, in satisfaction of said resonance condition at different angles in the regions of different measurement areas irradiated on a grating waveguide structure (c).

79. Method according to claim 78, wherein the excitation light is irradiated essentially in parallel and is essentially monochromatic.

80. Method according to claim 79, wherein the excitation light is irradiated linearly polarized, for excitation of a TE₀ or TM₀-mode guided in the layer (a).

81. Method according to any of claims 78-80, wherein the locally resolved determination of changes of the resonance conditions for incoupling of an excitation light into layer (a) or outcoupling of light guided in the waveguide (layer (a)), in the region of the measurement areas, is performed
by sequential collection of the transmitted excitation light and/or
by sequential collection of the light outcoupled again essentially in parallel to the reflected light at the same side of the grating waveguide structure, with respect to the side of irradiation of the excitation light and/or
by sequential collection of scattered light of excitation light guided in the layer (a) after incoupling by means of a grating waveguide structure (c), by means of one or more locally resolving detectors upon variation of the angle of incidence of the excitation light irradiated onto the grating waveguide structure.

82. Method according to claim 71, wherein the angle of incidence of the excitation light on the grating waveguide structure is adjusted in such a way that the resonance condition for incoupling of an excitation light into a waveguide with a grating waveguide structure or for outcoupling of light guided in the waveguide (layer (a)), comprising an array of at least two or more laterally separated measurement area (d) on said grating waveguide structure, is essentially satisfied
on one or more of said measurement areas, resulting in an essentially maximum signal from a locally resolving detector for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), from the region of said measurement areas and/or resulting in an essentially minimum signal from a locally resolving detector for collection of the transmitted excitation light from the region of the measurement areas
or is essentially satisfied between the measurement areas resulting in an essentially maximum signal from a locally resolving detector for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), from the regions between of measurement areas and/or resulting in an essentially minimum signal from a locally resolving detector for collection of the transmitted excitation light from the regions between the measurement areas.

83. Method according to claim 82, wherein local differences of the effective refractive index in the region of different measurement areas and in the regions between the measurement areas are determined from local differences of the intensities of one or more locally resolving detectors, for of the transmitted excitation light and/or for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), without changing the adjusted angle of incidence of the excitation light on the grating waveguide structure.

84. Method according to claim 71, wherein the locally resolved determination of changes of the resonance condition for the incoupling of an excitation light, from a light source tunable at least over a certain spectral range, into layer (a) or for the outcoupling of a light guided in the waveguide (layer (a)), in the region of the measurement areas, is performed by sequential collection of the transmitted excitation light and/or by sequential collection of the light outcoupled again essentially in parallel to the reflected light at the same side of the grating waveguide structure, with respect to the side of irradiation of the excitation light and/or by sequential collection of scattered light of excitation light guided in the layer (a) after incoupling by means of a grating waveguide structure (c), using one or more locally resolving detectors in each configuration and varying the emission wavelength of said at least one tunable light source, preferably at a constant angle of incidence of the excitation light on the grating waveguide structure.

85. Method according to claim 71, wherein the emission wavelength of at least one tunable light source is adjusted, preferably at a constant angle of incidence of this excitation light on the grating waveguide structure, in such a way that the resonance condition for incoupling of an excitation light into a waveguide of a grating waveguide structure or for outcoupling of light guided in the waveguide (layer (a)), comprising an array of at least two or more laterally separated measurement area (d) on said grating waveguide structure, is essentially satisfied
on one or more of said measurement areas, resulting in an essentially maximum signal from a locally resolving detector for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), from the region of said measurement areas and/or resulting in an essentially minimum signal from a locally resolving detector for collection of the transmitted excitation light from the region of the measurement areas
or is essentially satisfied between the measurement areas resulting in an essentially maximum signal from a locally resolving detector for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), from the regions between of measurement areas and/or resulting in an essentially minimum signal from a locally resolving detector for collection of the transmitted excitation light from the regions between the measurement areas.

86. Method according to claim 71, wherein the locally resolved determination of changes of the resonance condition for the incoupling of an excitation light into layer (a) or for the outcoupling of a light guided in the waveguide (layer (a)), from a polychromatic light source tunable at least over a certain spectral range, in the region of the measurement areas is performed by collection of the transmitted excitation light and/or by collection of the light outcoupled again essentially in parallel to the reflected light at the same side of the grating waveguide structure, with respect to the side of irradiation of the excitation light and/or by collection of scattered light of excitation light guided in the layer (a) after incoupling by means of a grating waveguide structure (c), using one or more locally resolving detectors in each configuration, the excitation light being preferably irradiated at a constant angle of incidence onto the grating waveguide structure, and wherein, upon satisfaction of the resonance condition of incoupling excitation light for a certain wavelength of said excitation light or outcoupling of excitation light of this wavelength guided in the waveguide a maximum signal fraction of this wavelength, as part of the signal from a locally resolving detector for collection of the light outcoupled again essentially in parallel to the reflected light at the same side of the grating waveguide structure, with respect to the side of irradiation of the excitation light and/or for collection of scattered light of excitation light guided in the layer (a) after incoupling by means of a grating waveguide structure (c), from the region of said measurement areas and/or a minimum signal fraction of this wavelength, as part of the signal from a locally resolving detector for collection of the transmitted excitation light from the region of the measurement areas is measured.

87. Method according to claim 86, wherein a spectrally selective optical component of high spectral resolution in said certain spectral range is located in the optical path between the grating waveguide structure and the at least one locally resolving detector.

88. Method according to claim 87, wherein spectrally selective, locally resolved, two-dimensional illustrations of the intensity distributions of the measurement light emanating from the grating waveguide structure, at different wavelengths within said certain spectral range, can be generated using said spectrally selective component.

89. Method according to any of claims 44-47, wherein the locally resolved determination of changes of the resonance conditions for incoupling of an excitation light into layer (a) or outcoupling of light guided in the waveguide (layer (a)), from said polychromatic light source in the region of the measurement areas, is performed
by simultaneous or sequential collection of the transmitted excitation light and/or
by simultaneous or sequential collection of the light outcoupled again essentially in parallel to the reflected light at the same side of the grating waveguide structure, with respect to the side of irradiation of the excitation light and/or
by simultaneous or sequential collection of scattered light of excitation light guided in the layer (a) after incoupling by means of a grating waveguide structure (c),
by means of spectrally selective detection, within said certain spectral range, using at least one locally resolving detector, preferably under irradiation of the excitation light onto the grating waveguide structure at a constant angle of incidence.

90. Method according to any of claims 86-89, wherein the excitation light is irradiated essentially in parallel.

91. Method according to any of claims 71-90, wherein the excitation light from the at least one light source is multiplexed to a plurality of individual rays of intensity as uniform as possible by a diffractive optical element, or in case of multiple light sources by multiple diffractive optical elements, which are preferably Dammann gratings, or by refractive optical elements, which are preferably microlens arrays, the individual rays being launched essentially parallel to each other onto laterally separated measurement areas.

92. Method according to claim 71, wherein the excitation light from at least one, preferably monochromatic light source is expanded to a ray bundle of intensity as homogeneous as possible, with a slit-type cross-section (in a plane perpendicular to the optical axis of the optical ray path), the main axis being oriented in parallel to the grating lines, by means of a beam shaping optics, wherein the individual rays of the ray bundle are essentially in parallel to each other in a plane of projection in parallel to the plane of the grating waveguide structure, and wherein said ray bundle has a convergence or divergence with a certain convergence or divergence angle in a plane perpendicular to the plane of the grating waveguide structure.

93. Method according to claim 92, wherein the angle of convergence of divergence of said ray bundle is smaller than 5° in a plane perpendicular to the plane of the grating waveguide structure.

94. Method according to any of claims 92-93, wherein the locally resolved determination of changes of the resonance conditions for incoupling of an excitation light into layer (a) or outcoupling of light guided in the waveguide (layer (a)), in the region of the measurement areas, within an irradiated region of slit-type cross-section, is performed
by simultaneous collection of the transmitted excitation light and/or
by simultaneous collection of the light outcoupled again essentially in parallel to the reflected light at the same side of the grating waveguide structure, with respect to the side of irradiation of the excitation light and/or
by simultaneous collection of scattered light of excitation light guided in the layer (a) after incoupling by means of a grating waveguide structure (c),
by means of one or more locally resolving detectors, wherein the local change of the resonance conditions in a measurement area is monitored
by a shift of the intensity maximum of the light emanating essentially in parallel to the reflected light from said measurement area and
by a shift of the intensity maximum of the scattered light of excitation light guided in the layer (a) after incoupling by means of a grating waveguide structure (c) and
by a shift of the intensity minimum of the light transmitted in the region of said measurement area (in each case at the condition of satisfaction of the resonance conditions in said measurement area), wherein the shift of said intensity maximum respectively intensity minimum occurs in a plane in parallel to the plane of the grating waveguide structure, perpendicular to the grating lines.

95. Method for the qualitative and/or quantitative determination of one or more analytes in one or more samples on at least two or more laterally separated measurement areas on a grating waveguide structure according to any of claims 1-29 in an optical system according to any of claims 34-70, upon determination of changes of the resonance conditions for incoupling of an excitation light into a waveguide or for outcoupling of a light guided in said waveguide, comprising an array of at least two or more laterally separated measurement areas (d) on said grating waveguide structure,
wherein the locally resolved determination of changes of said resonance conditions) is performed always simultaneously in the region of the measurement areas within an irradiated region of slit-type cross-section
by simultaneous collection of the transmitted excitation light and/or
by simultaneous collection of the light outcoupled again essentially in parallel to the reflected light at the same side of the grating waveguide structure, with respect to the side of irradiation of the excitation light and/or
by simultaneous collection of scattered light of excitation light guided in the layer (a) after incoupling by means of a grating waveguide structure (c),
by means of one or more locally resolving detectors, wherein the local change of the resonance conditions in a measurement area is monitored
by a shift of the intensity maximum of the light emanating essentially in parallel to the reflected light from said measurement area and
by a shift of the intensity maximum of the scattered light of excitation light guided in the layer (a) after incoupling by means of a grating waveguide structure (c) and
by a shift of the intensity minimum of the light transmitted in the region of said measurement area
(in each case at the condition of satisfaction of the resonance conditions in said measurement area),
wherein the shift of said intensity maximum respectively intensity minimum occurs in a plane in parallel to the plane of the grating waveguide structure, perpendicular to the grating lines,
and wherein the grating waveguide structure is moved perpendicular and/or in parallel to the direction of the grating lines between sequential measurement process steps, for a sequential locally resolved determination of said resonance conditions on the whole surface of the grating waveguide structure with the measurement areas provided thereon, until the measurement signals from all measurement areas are collected and stored and a two-dimensional representation of the degree of satisfaction of said resonance condition on the whole grating waveguide structure can be generated from the stored signals.

96. Method according to any of claims 78-95, wherein the lateral resolution for the determination of the degree of satisfaction of the resonance condition for incoupling of light into layer (a) can be improved by choice of a larger modulation depth of grating structures (c) or decreased by choice of a lower modulation depth of said grating structures.

97. Method according to any of claims 78-96, wherein the halfwidth of the resonance angle for satisfaction of the resonance condition for incoupling of light into layer (a) can be decreased by a decrease of the modulation depth of grating structures (c), resulting in an increased sensitivity for the laterally resolved determination of the degree of satisfaction of the resonance condition as a consequence from local changes of the mass coverage, or can be increased by an increase of the modulation depth of said grating structures, resulting in .a decreased sensitivity for the laterally resolved determination of the degree of satisfaction of the resonance condition as a consequence from local changes of the mass coverage.

98. Method according to any of claims 78-97, wherein differences of the mass coverage and/or of the effective refractive index can be resolved also within a measurement area.

99. Method according to any of claims 71-98, wherein two or more coherent light sources with equal or different emission wavelengths are used as excitation light sources.

100. Method according to any of claims 71-99, wherein a mass label, which can be selected from the group comprising metal colloids (such as gold colloids), plastic particles or beads or other microparticles with a monodisperse size distribution, is bound to the analyte molecules or to one of its binding partners in a multi-step assay, in order to increase the change of the mass coverage upon the binding to or dissociation of analyte molecules to be determined.

101. Method according to any of claims 71-100, wherein an “absorption label” is bound to the analyte molecules or to one of its binding partners in a multi-step assay, in order to increase the change of the effective refractive index upon binding or dissociation of analyte molecules to be determined, the “absorption label” having an absorption band of suitable wavelength resulting in a change of the effective refractive index in the near-field of the grating waveguide structure, the absorption being the imaginary part of the refractive index.

102. Method according to any of claims 71-101, wherein one or more luminescences, excited in the evanescent field of an excitation light guided in layer (a), are determined in addition to the locally resolved determination of changes of the resonance conditions for the incoupling of an excitation light into the layer (a) of a grating waveguide structure according to any of claims 1-29 or for the outcoupling of a light guided in said layer (a).

103. Method according to claim 102, wherein the binding of a ligand as an analyte to an immobilized biological or biochemical or synthetic recognition element as a receptor in one or more measurement areas is determined from the local change of the effective refractive index and a functional response of said ligand receptor system is determined from a change of a luminescence emanating from said measurement areas.

104. Method according to claim 102, wherein the density of immobilized biological or biochemical or synthetic recognition elements as receptors in one or more measurement areas is determined from the differences between the resonance conditions for the incoupling of an excitation light into the layer (a) of the grating waveguide structure or for the outcoupling of a light guided in said layer (a), in the region of said measurement areas, and the corresponding resonance conditions in the environment, i..e. outside of said measurement areas, and wherein the binding of a ligand as an analyte to said recognition elements is determined from a change of a luminescence emanating from said measurement areas.

105. Method according to any of claims 102- 104, wherein (firstly) the isotropically emitted luminescence or (secondly) luminescence that is incoupled into the optically transparent layer (a) and out-coupled by a grating structure (c) or luminescence comprising both parts (firstly and secondly) is measured simultaneously.

106. Method according to any of claims 102-105, wherein, for the generation of said luminescence, a luminescent dye or a luminescent nano-particle is used as a luminescence label, which can be excited and emits at a wavelength between 300 nm and 1100 nm.

107. Method according to any of claims 100-106, wherein the mass label and or the luminescence label is bound to the analyte or, in a competitive assay, to an analyte analogue or, in a multi-step assay, to one of the binding partners of the immobilized biological or biochemical or synthetic recognition elements or to the biological or biochemical or synthetic recognition elements.

108. Method according to any of claims 102-107, wherein the one or more determinations of luminescences and/or determinations of light signals at the excitation wavelengths are performed polarization-selective, wherein preferably the one or more luminescences are measured at a polarization that is different from the one of the excitation light.

109. Method according to any of claims 71-108 for the simultaneous or sequential, quantitative or qualitative determination of one or more analytes of the group comprising antibodies or antigens, receptors or ligands, chelators or “histidin-tag components”, oligonucleotides, DNA or RNA strands, DNA or RNA analogues, enzymes, enzyme cofactors or inhibitors, lectins and carbohydrates.

110. Method according to any of claims 71-109, wherein the samples to be examined are naturally occurring body fluids, such as blood, serum, plasma, lymph or urine or egg yolk or optically turbid liquids or surface water or soil or plant extracts or bio- or process broths or are taken from biological tissue parts.

111. The use of a grating waveguide structure according to any of claims-1-29 and/or of an optical system according to any of claims 30-70 and/or of a method according to any of claims 71-110 for qualitative and/or quantitative analyses for the determination of chemical, biochemical or biological analytes in screening methods in pharmaceutical research, combinatorial chemistry, clinical and preclinical development, for real-time binding studies and the determination of kinetic parameters in affinity screening and in research, for qualitative and quantitative analyte determinations, especially for DNA- and RNA analytics, for the generation of toxicity studies and the determination of expression profiles, and for the determination of antibodies, antigens, pathogens or bacteria in pharmaceutical product development and research, human and veterinary diagnostics, agrochemical product development and research, for symptomatic and pre-symptomatic plant diagnostics, for patient stratification in pharmaceutical product development and for the therapeutic drug selection, for the determination of pathogens, nocuous agents and germs, especially of salmonella, prions and bacteria, in food and environmental analytics.
